(19) United States
(12) Patent Application Publication
(10) Pub. No.: US 2025/0069052 A1
(43) Pub. Date: Feb. 27, 2025

(54) INTELLECTUAL PROPERTY ASSET FRACTIONAL PAYMENT SYSTEM AND METHOD

(71) Applicant: Songchain LLC, Nashville, TN (US)

(72) Inventor: Benjamin Holman Richards, IV, Nashville, TN (US)

(21) Appl. No.: 18/523,094

(22) Filed: Nov. 29, 2023

Related U.S. Application Data
(60) Provisional application No. 63/429,410, filed on Dec. 1, 2022.
(60) Provisional application No. 63/593,649, filed on Oct. 27, 2023.

(51) Int. Cl. G06Q 20/12; G06Q 20/02; G06Q 20/36; G06Q 20/38; G06Q 20/40

(52) U.S. Cl. CPC G06Q 20/1235; G06Q 20/02; G06Q 20/3672; G06Q 20/3829; G06Q 20/405; G06Q 2220/00

(57) ABSTRACT

A blockchain-based intellectual property (“IP”) asset fractional payment system and method that facilitates sharing a revenue stream generated from an intellectual property asset among individuals having a fractional ownership of the revenue stream generated. A fractional ownership platform is employed where each fraction purchased may subsequently be divided into fractions of fractions, and those fractions can be sold or transferred without limitation. Both the IP asset created, and each fractional ownership share of a revenue stream generated therefrom may digitally represented using an NFT such that a smart contract on a blockchain may be employed to enable and facilitate fractional ownership tracking among the IP asset's owner and any number of third parties holding fractional ownership of the IP asset's associated revenue stream and payment distribution to the IP asset owner and all fractional owners.

### CROSS-REFERENCE TO RELATED APPLICATIONS

This application claims the benefit of U.S. Provisional Patent Application 63/429,410, filed Dec. 1, 2022, and U.S. Provisional Patent Application 63/593,649, filed Oct. 27, 2023, each of which is hereby incorporated by reference herein in its entirety.

### FIELD OF THE INVENTION

The present invention relates generally to intellectual property monetization, and more particularly, to a blockchain-based intellectual property asset fractional payment system and method that facilitates sharing a revenue stream generated from an intellectual property asset among individuals having a fractional ownership of the revenue stream generated.

### BACKGROUND OF THE INVENTION

The field of intellectual property is continuously expanding and evolving. Intellectual property has traditionally been defined as trademarks, patents, copyrights, and trade secrets. More and more, theorists are enlarging the concept to include “intellectual capital,” a term becoming well-known in the field. That is, the term “intellectual property” (“IP”) may have a broad definition comprising not only the foregoing definitions, but also including technology (e.g., hardware, software, computer programs and systems, training methods, methods of doing business) embodying the intellectual property, as well as the know-how and methods for using the intellectual property. Intellectual property has become increasingly more important in today's global economy. Intellectual property can be viewed as a new type of currency in this economy because it is now more easily translatable to value, and vehicles for ownership of that intellectual property such as patents and copyrights, can store that value. Intellectual property assets, based for example on underlying copyright, patent, trademark or trade secret rights, often provide substantial revenue streams that may continue for several years. As such, intellectual property has proven to be and continues to be looked upon as a vital asset and focus of companies, universities, research organizations, performers, artists, and individuals. For example, a music copyright to a certain song may be the underlying basis providing a songwriter, a recording artist, a publisher and a record company with a stream of revenue from various royalties. Among these royalties may be publishing royalties, performance royalties, and artist royalties. An intellectual property asset of a songwriter thus may include the writer's share of publishing rights and performance royalties for various songs protected by copyright. The owner of a patent who has licensed the patent may receive royalty streams from licensees of that patent in different geographic regions of the country in which the patent is held, for different fields of use of the invention. The royalty streams may include fixed periodic payments as well as payments based on sales of products incorporating the invention. The owner may hold patent rights in several different countries for the same invention, and therefore may receive royalty streams from domestic and foreign uses of the invention. The owner of a trademark or trade secret rights may similarly have several categories of revenue streams based on their rights to that intellectual property. The revenue streams may include various types of licensing payments in categories similar to those for a patent license.

Historically it has only been feasible for businesses to facilitate royalty investments to creators of the intellectual property assets. For example, with respect to a copyright asset the business, typically referred to as a publisher, provides a monetary advance to a creator which provides them with an income stream today with the expectation that the advance will be recouped from royalties generated in the future. Typical arrangements consist of the publisher advancing money to a songwriter, with an agreement of the future income to be split according to the terms of their contract after the recoupment of the initial advance. There are administrative costs and processes that make this process burdensome for any individual who does not participate professionally in the industry of publishing. When payments are collected by the publisher they require their own internal systems for distribution, accounting, and managing the legality of recoupment and distribution of the payment to the songwriter after recoupment of the initial advance. As such, it not economically practical or feasible for an individual to enter into a contract with a songwriter if they have a limited budget because the legal fees, the process, and the administration requirements are such that there is a meaningful barrier to entry for anyone who is not professionally invested in the business of publishing. In short, the cost of doing business is higher than the profit generated from the publishing deal.

When income is derived from the investment (i.e., the creative asset) the revenue must be collected and then proportionally distributed based upon the legal terms of the governing intellectual property agreement (e.g., a publishing agreement). The receivers of the distribution are directly or indirectly parties to the original intellectual property agreement. For example, a publishing business or individual that signed the publishing contract with the artist is the direct beneficiary of the distribution of funds. Each of the parties of the contract are known at all times and typically the assignment of the rights to receive this distribution of funds is not transferable without the agreement of the artist/creator. Further, in the current publishing industry all parties that are entitled to the royalty derived income are typically known at all times.

Creating and leveraging intellectual property to generate revenue has become a priority for many corporations and individuals, particularly those with significant intellectual property portfolios. Given the increased focus and value placed upon the monetization of intellectual property assets, owners of intellectual property assets and others continue to investigate various revenue generation and securitization alternatives. For example, there is no mechanism in this typical intellectual property ecosystem to allow for the rights to future income to be further fractionalized. That is, if the publishing business wishes to generate income from their publishing rights, they may have to sell their representation of the original asset. Thus, there is a need for managing the life cycle of intellectual property assets to maximize and diversify revenue potential.

Accordingly, there is need for a system and method that facilitates sharing a revenue stream generated from an intellectual property asset among individuals having a fractional ownership of the revenue stream generated.

### SUMMARY OF THE INVENTION

The present invention is directed to a blockchain-based intellectual property asset fractional payment system and method that facilitates sharing a revenue stream generated from an intellectual property asset among individuals having a fractional ownership of the revenue stream generated.

In a first implementation of the invention, an intellectual property asset fractional payment method is provided that facilitates sharing a revenue stream generated from an intellectual property asset among individuals having a fractional ownership of the revenue stream generated. The method comprising: (i) establishing a smart contract on a distributed ledger technology (DLT) governing an agreement by an intellectual property asset owner to offer fractional ownership shares to a plurality of third parties in revenue generated from an intellectual property asset created by the intellectual property asset owner, wherein each fractional ownership share offered entitles any one of third parties to receive a portion of the revenue stream generated from the intellectual property asset commensurate with a number of fractional ownership shares owned by the third party; (ii) assigning, using the smart contract, an asset identification code specific to the intellectual property asset; (iii) receiving from the intellectual property asset owner an identification of an initial number of fractional ownership shares offered for sale to a plurality of third parties; (iv) assigning a first fractional ownership percentage in accordance with the initial number of fractional ownership shares offered for sale; (v) issuing to the intellectual property asset owner a first digital key comprising the first fractional ownership percentage assigned, and (vi) minting a non-fungible token (NFT) for tokenizing each individual fractional ownership share of the initial number of fractional ownership shares offered for sale. The individual fractional ownership shares represented by the NFTs are employed for the intellectual property creator and other third parties to share in the revenue stream generated from the intellectual property asset and to actively buy and sell the individual fractional ownership shares. Each fractional share is uniquely identifiable and may be traced to the original fractional share from which it was derived.

In a second aspect, an intellectual property asset fractional payment system is provided for facilitating intellectual property asset fractional payment processing. The system comprising at least: a processor and a memory storing instructions that when executed cause the processor to perform operations comprising: (i) establishing a smart contract on a DLT governing an agreement by an intellectual property asset owner to offer fractional ownership shares to a plurality of third parties in revenue generated from an intellectual property asset created by the intellectual property asset owner, wherein each fractional ownership share offered entitles any one of third parties to receive a portion of the revenue stream generated from the intellectual property asset commensurate with a number of fractional ownership shares owned by the third party; (ii) assigning, using the smart contract, an asset identification code specific to the intellectual property asset; (iii) receiving from the intellectual property asset owner an identification of an initial number of fractional ownership shares offered for sale to a plurality of third parties; (iv) assigning a first fractional ownership percentage in accordance with the initial number of fractional ownership shares offered for sale; (v) issuing to the intellectual property asset owner a first digital key comprising the first fractional ownership percentage assigned; and (vi) minting a NFT for tokenizing each individual fractional ownership share of the initial number of fractional ownership shares offered for sale.

In a third aspect, a user device is provided and configured for facilitating intellectual property asset fractional payment processing. The user device comprising at least a processor, a display and a memory storing instructions that when executed cause the processor to perform operations comprising: (i) establishing a smart contract on a DLT governing an agreement by an intellectual property asset owner to offer fractional ownership shares to a plurality of third parties in revenue generated from an intellectual property asset created by the intellectual property asset owner, wherein each fractional ownership share offered entitles any one of third parties to receive a portion of the revenue stream generated from the intellectual property asset commensurate with a number of fractional ownership shares owned by the third party; (ii) assigning, using the smart contract, an asset identification code specific to the intellectual property asset; (iii) receiving from the intellectual property asset owner an identification of an initial number of fractional ownership shares offered for sale to a plurality of third parties; (iv) assigning a first fractional ownership percentage in accordance with the initial number of fractional ownership shares offered for sale; (v) issuing to the intellectual property asset owner a first digital key comprising the first fractional ownership percentage assigned; and (vi) minting a NFT for tokenizing each individual fractional ownership share of the initial number of fractional ownership shares offered for sale.

In a fourth aspect, intellectual property asset fractional payment application (alternatively referred to herein as an “app”) is provided for executing, on a user device, an intellectual property asset fractional payment system, and/or other hardware and facilitating intellectual property asset fractional payment processing that employs a smart contract on a DLT governing an agreement by an intellectual property asset owner to offer fractional ownership shares to a plurality of third parties in revenue generated from an intellectual property asset created by the intellectual property asset owner, wherein each fractional ownership share offered entitles any one of third parties to receive a portion of the revenue stream generated from the intellectual property asset commensurate with a number of fractional ownership shares represented as NFTs and owned by the third party.

In a further aspect, the intellectual property asset created by the intellectual property asset owner is published on a marketplace platform together with the initial number of fractional ownership shares offered for sale.

In a further aspect, a purchasing request is received from a first one of a plurality of third parties for purchasing a specific number of fractional ownership shares of the initial number of fractional ownership shares offered for sale associated with the intellectual property asset published.

In a further aspect, responsive to the purchasing request received from the first third party, a second fractional ownership percentage is assigned in accordance with specific number of fractional ownership shares specified in the purchasing request received, a second digital key is issued to the first thirst party comprising the second fractional ownership percentage assigned, the first fractional ownership percentage assigned is adjusted by decreasing the first fractional ownership percentage by the second fractional ownership percentage assigned, and the first digital key issued is updated with the first fractional ownership percentage adjusted.

In a further aspect, a first monetary payment is issued to the intellectual property asset owner, the first monetary payment being determined as a function of the second fractional ownership percentage assigned and the revenue stream generated from the intellectual property asset.

In a further aspect, a resale request is received from the first third party to offer for resale a specific number of fractional ownership shares of the second fractional ownership percentage assigned.

In a further aspect, the specific number of fractional ownership shares of the second fractional ownership percentage assigned and offered for resale by the first third party are published on the marketplace platform.

In a further aspect, a purchasing request is received from a second one of the plurality of third parties for a specific number of fractional ownership shares of the specific number of fractional ownership shares of the second fractional ownership percentage assigned offered for resale by the first third party published.

In a further aspect, responsive to the purchasing request received from the second third party, a third fractional ownership percentage is assigned in accordance with the specific number of fractional ownership shares of the specific number of fractional ownership shares of the second fractional ownership percentage assigned offered for resale by the first third party, a third digital key is issued to the second third party comprising the third fractional ownership percentage assigned, the first fractional ownership percentage assigned is adjusted by decreasing the first fractional ownership percentage by the third fractional ownership percentage assigned, the second fractional ownership percentage assigned is adjusted by decreasing the second fractional ownership percentage by the third fractional ownership percentage assigned, the first digital key issued is updated with the first fractional ownership percentage adjusted, and the second digital key issue is updated with the second fractional ownership percentage adjusted.

In a further aspect, a second monetary payment is issued to the intellectual property asset owner, the second monetary payment determined as a function of the third fractional ownership percentage assigned and the revenue stream generated from the intellectual property asset.

In a further aspect, the intellectual property asset is an original work of authorship, a patent, copyright, or a trademark.

In a further aspect, the smart contract specifies a date upon which ownership of all fractional ownership shares revert back to the intellectual property creator.

In a further aspect, the publishing of the intellectual property asset on the marketplace platform is administered by and on the DLT.

In a further aspect, the intellectual property asset is represented using an NFT.

In a further aspect, the asset identification code assigned is defined by the intellectual property creator.

In a further aspect, the DLT is a blockchain.

In a further aspect, consideration distributed in accordance with the fractional share ownership may be on a non-monetary basis using in-kind considerations including, but not limited to, such as exclusive access.

The methods and systems described herein can be implemented by data processing systems, such as one or more smartphones, tablet computers, desktop computers, laptop computers, smart watches, wearable, audio accessories, on-board computer, and other data processing systems and other consumer electronic devices. The methods and systems described herein can also be implemented by one or more data processing systems which execute executable computer program instructions, stored in one or more non-transitory machine-readable media that cause the one or more data processing systems to perform the one or more methods described herein when the program instructions are executed. Thus, the embodiments described herein can include methods, data processing systems, and non-transitory machine-readable media.

The above summary does not include an exhaustive list of all embodiments in this disclosure. All systems and methods can be practiced from all suitable combinations of the various aspects and embodiments summarized above, and also those disclosed in the detailed description below.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 presents a high-level block diagram of a cloud network services architecture for providing an intellectual property asset fractional payment system in accordance with an embodiment;

FIG. 2 presents an illustrative intellectual property asset fractional payment system in accordance with an embodiment;

FIG. 3 presents an illustrative user device configured for facilitating intellectual property asset fractional payments in accordance with an embodiment;

FIG. 4 presents an illustrative architecture for an intellectual property asset fractional payment system app in accordance with an embodiment;

FIG. 5 an illustrative mesh network is shown between various parties for engaging in blockchain-based intellectual property asset fractional payments in accordance with an embodiment;

FIG. 6 presents an illustrative intellectual property asset fractional payment blockchain interaction in accordance with an embodiment;

FIG. 7 presents a block diagram illustrating an example token that can be non-fungible and that can represent an intellectual property asset for engaging in blockchain-based intellectual property asset fractional payments in accordance with an embodiment;

FIG. 8 presents an exemplary operational and data flow diagram illustrating operations that occur during intellectual property asset fractional payment transactions in accordance with an embodiment;

FIG. 9 presents a series of NFT fractional ownership examples between an intellectual property creator and third parties resulting from the intellectual property asset fractional payment transactions of FIG. 8 in accordance with an embodiment;

FIG. 10 presents an exemplary operational and data flow diagram illustrating operations that occur during intellectual property asset fractional payment transactions that include fund withdrawals in accordance with an embodiment;

FIG. 11 presents a flow and fractional share diagram outlining one example of intellectual property asset fractional payment transactional processing in accordance with an embodiment; and

FIG. 12 presents an exemplary operational and data flow diagram illustrating proof of ownership of fractional shares in accordance with the embodiment.

Like reference numerals refer to like parts throughout the several views of the drawings.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Shown throughout the figures, the present invention is directed toward a blockchain-based intellectual property (“IP”) asset fractional payment system and method that facilitates monetization of an IP asset through the sharing of a revenue stream generated from the IP assets asset (also referred to herein as a “royalty asset”) among individuals (some of which may not be the creator of the intellectual property asset) having a fractional ownership of the revenue stream generated. In a further aspect, consideration distributed in accordance with the fractional share ownership may be on a non-monetary basis using in-kind considerations including, but not limited to, such as exclusive access. As such, users (e.g., intellectual property creators and third parties) may engage in IP asset monetization and revenue stream sharing in a fully transparent, secure, and anonymous fashion. The system and method provide for a fractional ownership platform where each fraction purchased may subsequently be divided into fractions of fractions, and those fractions can be sold or transferred without limitation. Both the IP asset created, and each fractional ownership share of a revenue stream generated therefrom may be digitally represented using an NFT such that a smart contract on a DLT ledger (e.g., a blockchain) may be employed to enable and facilitate fractional ownership tracking among the IP asset's creator and any number of third parties holding fractional ownership of the IP asset's associated revenue stream and payment distribution to the IP asset creator and all fractional owners. For example, the creator of the IP asset may receive automatic payments upon every resale, in whole or in part, of any fractional ownership derived from their created IP asset and any associated revenue stream generated therefrom. Importantly, the intellectual property asset fractional payment system and method of the disclosed embodiments provides an advantageous improvement of practical applications including, but not limited to, IP asset monetization platforms and blockchain-based transaction systems. This solves a transparency problem and increases the availability, security and anonymity of IP asset revenue stream sharing and provides for the definition and execution of dynamic fractional ownership using blockchains, smart contracts and tokenized IP assets and fractional ownership shares using NFTs. Importantly, in accordance with the principles of the disclosed embodiments, the intellectual property asset fractional payment transactions are executed employing at least one smart contract as stored and deployed into at least one DLT ledger utilized and managed by an intellectual property asset fractional payment system. Thus, in accordance with principles of the disclosed embodiments, fractional sales may continue for an unlimited number of fractions to an unlimited number of parties. Further, the entirety of the fractional share transactions and associated payments may occur on a completely anonymous basis unless the involved parties prefer otherwise. Central to these operations, as will be further detailed herein below, is the use of a centralized database for collecting and distributing payments, a decentralized ledger the records the transaction history, an immutable contract specifying and delivering the terms of fractional payment distributions, one or more user devices (e.g., a mobile device), and an intellectual property asset that holds potential to generate a revenue stream.

Advantageously, the system and method in accordance with the disclosed embodiment creates a payment distribution ledger to disperse a royalty generated payment, which is not tied to a specific individual or business. The right to receive the payment distribution is assigned to an anonymous digital secret key. Whoever can establish and prove possession and knowledge of that digital key is entitled to the payment. Thus, the terms of the publishing fractional ownership are dynamic, in that they are not set at the time of contract execution or definition of the term. The agreement for fractional payment distribution may start with the creator being entitled to 100% of the fractions and change dynamically over time as other third parties purchase the entitlement to a fractional payment. On the day the IP owner publishes the intellectual property asset (or royalty asset) as being available for purchase the creator may own 100% of the fractions, and within a short or long period of time their ownership may be between 0-100% based on how many fractions are sold. After a period of time, some or all of the fractional ownership may be reverted to the original creator (or owner) based on the specific offering of the fractional sale. To avoid confusion, it will be understood that the IP asset creator is the individual who created the IP asset (i.e., the IP asset creator). Alternatively, an IP owner is an individual who is the current owner of the IP asset (e.g., having received an ownership interest, in whole or in part, in the IP asset from the IP asset creator and/or another IP owner). Thus, the IP asset creator may also be the IP owner and the IP owner may not necessarily be the IP asset creator, depending upon the context. Illustratively, the IP asset creator may have sold their entire right, title, and interest to the IP asset to the IP owner for a monetary payment and the parties may have executed an IP assignment agreement transferring ownership from the IP asset creator to the IP owner. For example, a music publisher may own the rights to royalties for a specified period of time (e.g., five (5) years). Under a publishing contract with the songwriter, they are legally entitled to extract value from their IP ownership under the contract such that publisher may use the intellectual property asset fractional payment system and method hereunder to offer fractional ownership of the publishing rights they own for the specified five years. As will be appreciated, while the disclosure focuses on the monetization of an intellectual property asset it will be understood that the principles of the disclosed embodiments apply equally to any asset capable of being monetized and generating a revenue stream or other value proposition.

To provide further context for the subject disclosure, a high-level discussion of DLT, blockchain and smart contracts will now be discussed A blockchain is a distributed database that records all transactions that have ever occurred in a network, for example. Blockchain was originally introduced for Bitcoin (a peer-to-peer digital payment system), but then evolved to be used for developing a wide range of decentralized applications. A blockchain is a distributed digital ledger which is communicated electronically between hardware devices. Each transaction recorded within the digital ledger is a block which can be hashed or otherwise encrypted. As new transactions are added to the digital ledger, each transaction's veracity can be tested against the previous ledger stored by the devices. In some configurations, there may be a requirement that some fixed percentage (e.g., fifty percent (50%)) of the user devices must confirm the transaction's veracity before being added to the blockchain. As such, a blockchain is a distributed database that records all transactions that have ever occurred in the blockchain network. This database is replicated and shared among the network's participants (or a subset thereof in some implementations). The main feature of blockchain is that it allows untrusted participants to communicate and send transactions between each other in a secure way without the need of a trusted third party. In this way, blockchain is an ordered list of blocks, where each block is identified by its cryptographic hash. Each block references the block that came before it, resulting in a chain of blocks. Each block consists of a set of transactions. Once a block is created and appended to the blockchain, the transactions in that block cannot be changed or reverted. This is to ensure the integrity of the transactions, for example, the IP asset monetization in accordance with the principles of the embodiments herein.

In essence, as noted previously, a blockchain is a transaction ledger that maintains identical copies across each computer of a member network and the fact that the ledger is distributed across part of the network facilitates the security of blockchain. A blockchain relies on three important components: private key technology, a distributed network that includes a shared ledger, and an accounting means for the transactions and records across the network. A blockchain is a list of records that are cryptographically linked together such that each block of the blockchain contains a cryptographic hash of the previous block, a timestamp, and transaction data. Thus, a blockchain is highly resistant to date modification due to the design feature that once recorded the data in any given block cannot be altered without alteration of all subsequent blocks. In many applications, the constructed distributed ledger is managed within a peer-to-peer network that allows participants to verify and audit transactions in an efficient manner By combining the use of cryptographic keys with a distributed network, blockchain expands the type and number of digital transaction possibilities.

An appealing application that can be deployed on top of blockchain are so-called smart contracts. A smart contract is executable code that runs on the blockchain to facilitate, execute, and enforce the terms of an agreement between parties. It can be thought of as a system that releases digital assets to all or some of the involved parties once the pre-defined rules have been met. The main aim of a smart contract is to automatically execute the terms of an agreement once the specified conditions are met. Before a smart contract may process transactions, the smart contract must be deployed on the blockchain. The deployment process must guarantee that all blockchain nodes have exactly the same program code. Generally, blockchain designs employ two smart contract deployment approaches. One approach is to save the smart contract code itself in the blockchain thereby guaranteeing global node consensus (so-called “on-chain”), and the other is to allow each node owner to decide if the node should have the code installed locally and use a hash-based commitment in the blockchain as reference for validating the integrity thereof (so-called “off-chain). Smart contracts are executed by the blockchain nodes, as a result of processing transactions that are submitted by the user. A blockchain transaction has a designated smart contract function and a payload that contains input values to the function call. A transaction may be submitted at any node in the blockchain network, which broadcasts the transaction to the entire network, so all of the nodes are aware of the transaction. At a particular point, the transaction is processed by each of the nodes using the executable program code in the target smart contract (herein, the smart contract triggers revenue sharing payments in accordance with fractional shares held by the IP asset's creator and third parties in a revenue stream generated from that IP asset). If the transaction is successful, the internal state of the blockchain will be updated. If the trigger (the triggering invocation request hereunder) input is determined to be invalid and rejected by the smart contract, then the overall state is not affected. For example, the smart contract may be triggered by a specific event (“if A happens, then action B”). In this way, a smart contract functions as a trusted distributed application that gains security/trust from the blockchain and the underlying consensus among the peers. Smart contracts must be independently executed by a quorum of blockchain nodes. Unlike traditional database structures, blockchains are decentralized such that every node assumes other nodes are potentially malicious and a node never trusts states maintained by other nodes in the network. Instead, each node maintains their own state database by executing the transaction itself using the smart contract code. Thus, each smart contract maintains their own set of states and most transactions submitted to a blockchain target a smart contract (with the execution of pure value transfers that do not involve smart contracts). Once a transaction is executed, the target smart contract update its state and one smart contract may call another smart contract in order to query, for example, the downstream smart contract's state or update the same. Only valid transactions result in updated states and invalid transactions are either rejected by the blockchain network from being included in the blockchain or included but marked as failed depending upon the particular blockchain design. In this way, the deployed smart contract serves as a form of execution logic for a blockchain application (e.g., the blockchain-based intellectual property asset fractional payment processing hereunder). Thus, smart contracts promise low transaction fees compared to traditional systems that require a trusted third party to enforce and execute the terms of an agreement.

Ethereum is a public blockchain platform that can support advanced and customized smart contracts with the help of Turing-complete programming language. Ethereum is a decentralized blockchain platform that establishes a peer-to-peer network that securely executes and verifies application code, called smart contracts. Ethereum is a platform powered by blockchain technology may be best known for its native cryptocurrency, called ether (or ETH), or simply Ethereum. In this way, a user/sender must sign transactions and spend ETH as a cost of processing transactions on the network. Smart contracts, as further detailed below, allow participants to transact with each other without a trusted central authority. Transaction records are immutable, verifiable, and securely distributed across the network, giving participants full ownership and visibility into transaction data. Transactions are sent from and received by user-created Ethereum accounts. Ethereum offers an extremely flexible platform on which to build decentralized applications using the native Solidity scripting language and Ethereum Virtual Machine (EVM). The code of Ethereum smart contracts is written in a stack-based bytecode language and executed in the EVM. Several high-level languages (e.g., Solidity and Serpent) can be used to write Ethereum smart contracts. The code of those languages can then be compiled into EVM bytecodes to be run. Decentralized application developers who deploy smart contracts on Ethereum benefit from the rich ecosystem of developer tooling and established best practices that have come with the maturity of the protocol. This maturity also extends into the quality of user-experience for the average user of Ethereum applications, with digital/cryptocurrency wallets such as MetaMask, Argent, Rainbow and more offering simple interfaces through which to interact with the Ethereum blockchain and smart contracts deployed thereon. Ethereum's large user base encourages developers to deploy their applications on the network, which further reinforces Ethereum as the primary platform for decentralized applications like decentralized finance (DeFi), decentralized applications (dApps), and NFTs. The distributed nature of blockchain technology is what makes the Ethereum platform secure, and that security enables ETH to accrue value.

Another blockchain platform that is increasingly gaining traction is the Hyperledger Fabric (also referred to as “Fabric”) as established by the Linux Foundation (see, e.g., LFS272: Hyperledger Fabric Administration, version 8.24, dated May 26, 2021) with a major focus on enterprise uses that require participants to be identified/identifiable, permissioned networks, high transaction throughput performance, low latency of transaction confirmation and privacy and confidentiality of transactions and data pertaining to business transactions. Fabric is the first distributed ledger platform to support smart contracts authored in general-purpose programming languages such as Java, rather than domain-specific languages (DSL). As such, enterprises can more easily develop smart contracts without the need to learn a specific/new programming language. The Fabric platform is also permissioned in that, unlike a public permissionless network, the participants are known to each other, rather than anonymous and therefore fully untrusted. This means that while the participants may not fully trust one another (e.g., if they are adverse parties or competitors) a network can be operated under a governance model that is constructed as a function of whatever trust does exist between participants, such as a legal framework. These features make Fabric one of the better performing platforms that are currently available both in terms of transaction processing and transaction confirmation latency. Further, this platform enables privacy and confidentiality of transactions and smart contracts that implement them.

Fabric has been specifically designed with a modular architecture making it very adaptable and customizable for various use cases. The modular components include (i) a pluggable ordering service that established consensus on the order of transactions and then broadcasts blocks to peers; (ii) a pluggable membership service provider that is responsible for associating entities in a network with cryptographic identities; (iii) smart contracts (so-called chain code) run within a contained environment for isolation and can be written in standard programming languages; (iv) the ledger can be configured to support a variety of database management systems (DBMS); and (v) a pluggable endorsement and validation policy enforcement can be independently configured per application. As noted above, in accordance with the principles of the disclosed embodiments, a smart contract is deployed on a blockchain DLT to enable and facilitate fractional ownership tracking among the IP asset's creator and any number of third parties holding fractional ownership of the IP asset's associated revenue stream and payment distribution to the IP asset creator and all fractional owners. For example, the creator of the IP asset may receive automatic payments upon every resale, in whole or in part, of any fractional ownership derived from their created IP asset and any associated revenue stream generated therefrom.

In accordance with the disclosed embodiments herein, encrypted data in the form of non-fungible tokens (NFTs) are employed for digitally representing an IP asset and the fractional ownership shares associated with a revenue stream generated from that IP asset. As will be appreciated, an NFT is a unit of data stored on a digital ledger (as detailed above), that certifies a digital asset to be unique and therefore not interchangeable. NFTs are a digital assets that can be used to represent items including, not limited to, photos, videos, audio, property, and other types of digital files. Currently, NFTs are bought and sold online, frequently with cryptocurrency, and they are generally encoded with the same underlying software as many cryptocurrencies. Access to any copy of the original file, however, is not restricted to the owner of the NFT. While copies of these digital items are available for anyone to obtain, NFTs are tracked on a blockchain to provide the owner with a proof of ownership that is separate from a copyright, for example. That is, an NFT is a unit of data stored on the digital ledger (e.g., the blockchain), which can be sold, traded and/or transferred. The NFT can be associated with a particular digital or physical asset (such as a file or a physical object) and a license to use the asset for a specified purpose or for transferring the ownership of the asset from one owner to another. NFTs (and the associated license to use, copy or display the underlying asset or the ownership assignment thereof) can be traded and sold on digital markets. In this way, NFTs function like cryptographic tokens, but, unlike other tokens (e.g., Bitcoin), NFTs are not mutually interchangeable, hence not fungible. Thus, each NFT may represent a different underlying individual asset and thus have a different value. NFTs are created, for example, when blockchains string records of cryptographic hash a set of characters identifying a set of data onto previous records thereby creating a chain of identifiable data blocks. This cryptographic transaction process ensures the authentication of each digital file by providing a digital signature that is used to track NFT ownership. An NFT is a unique digital token, with most using, for example, the above-referenced Ethereum blockchain to digitally record transactions. Again, the NFT is not a cryptocurrency like Bitcoin or Ethereum, because those are fungible (i.e., exchangeable for another Bitcoin or cash). However, NFTs are recorded in the digital ledger in the same way as cryptocurrency, so there is a listing of who owns each one. In this way, blockchains act as a decentralized system for recording and documenting transactions that involve a specific NFT and/or a plurality of NFTs. In essence, as noted previously, a blockchain is a transaction ledger that maintains identical copies across each computer of a member network and the fact that the ledger is distributed across part of the network facilitates the security of blockchain.

As will be appreciated, transacting smart contracts and NFTs carries an associated expense when using Ethereum. Gas refers to the computational effort required to execute operations on the blockchain, and any user must pay a gas fee in order to make transactions or executed smart contracts on Ethereum, for example. Further, gas is the term given to the fee that most NFT trading platforms charge. Thus, gas fees are incurred to conduct the transaction or execute a smart contract on their blockchain platform. For example, gas prices in Ethereum are denoted by a unit of gwei, which itself is a denomination of ether (ETH) that is the native cryptocurrency of the Ethereum platform. Each gwei is equal to 0.000000001 ETH. For example, instead of designating that the user's gas costs 0.000000001 ether, this translates to a cost of 1 gwei. The valuation is determined by the amount of traffic on the network and the computation power taken to execute a transaction. Gas fees are payments that users have to make to compensate for the computation energy required to process transactions on the Ethereum blockchain. Ethereum implements something called the proof of work algorithm. In this blockchain, validators who use special algorithms (called miners) solve cryptographic problems. Finding a successful solution to this problem enables sets of transactions to be processed and added to the blockchain. Everything on Ethereum network costs some denomination of gas. Interestingly, one difference between Hyperledger Fabric is that the Fabric platform does not currently have any native token or cryptocurrency in the system. So, a user currently does not need to have cryptocurrency in order to use this platform and there is no notion of gas. Gas on the Ethereum network is assigned a market price based upon the demand for resources in the network at a particular moment in time. Therefore, the valuation of Ethereum gas depends upon the supply and demand in the network. If there is high demand for transactions, this requires more miners to complete complicated algorithms creating more work and energy consumption; hence increasing the gas fee. If the gas price does not meet the threshold power, it cannot process the transactions. The user may decide the maximum gas amount they want to spend on a transaction and may set a limit on the gas price expended and wait until such price reaches that limit. This ensures that a user has some control over the transaction expenses. For example, if a user is willing to wait then the transaction will get processed when the gas limit set has been reached. The main criteria for gas expenses will depend upon the size of the smart contract for execution on the blockchain as well as the speed at which the user wants that transaction to be completed.

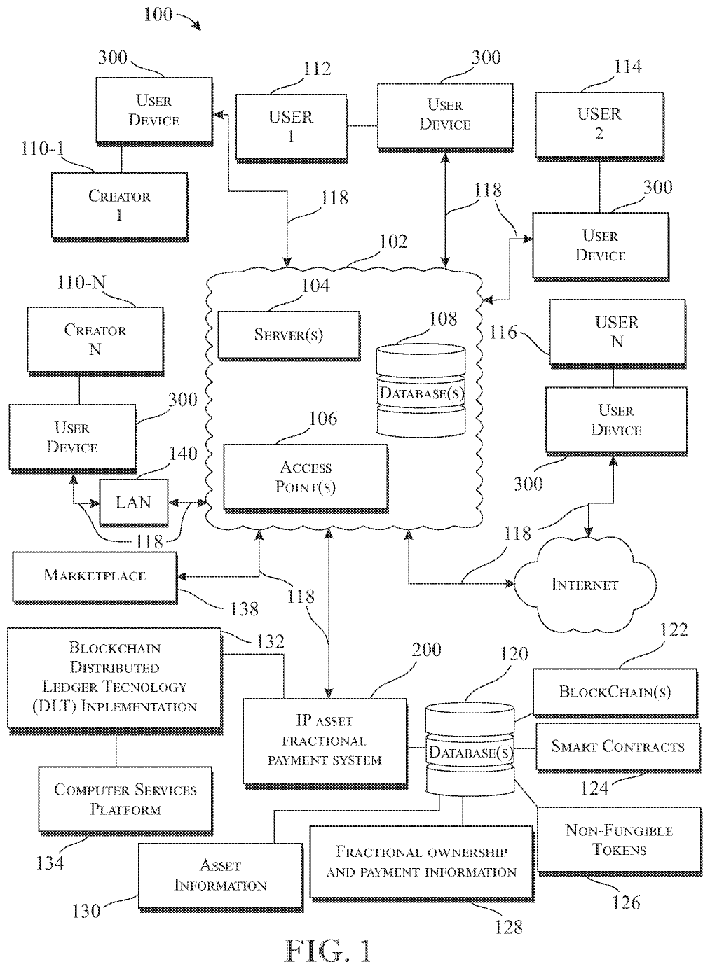

Turning our attention to FIG. 1, a high-level block diagram is presented of cloud network services architecture 100 comprising a cloud 102 for executing blockchain-based intellectual property asset fractional payment services to users. As shown for instance in FIG. 1, the cloud network services architecture 100 includes the cloud 102 comprising at least server(s) 104, access point(s) 106 and database(s) 108. As will be detailed herein below, the cloud 102 facilitates the delivery of blockchain-based intellectual property asset fractional payment services to a plurality of users (e.g., creator 1 110-1 through creator N 110-N, user 1 112, and user 2 114 through user N 116). References to “user”, or any similar term, as used herein, may mean any human (e.g., a person or individual) or non-human user and the term “user” is contemplated to mean users at any stage of the usage process including, without limitation, direct user(s), intermediate user(s), indirect user(s), and end user(s).

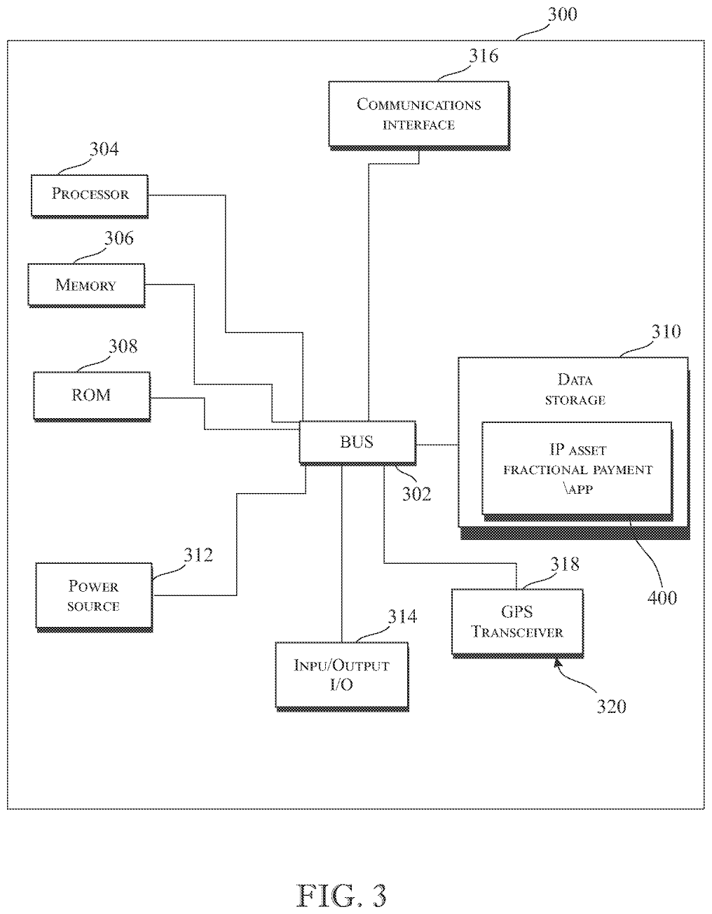

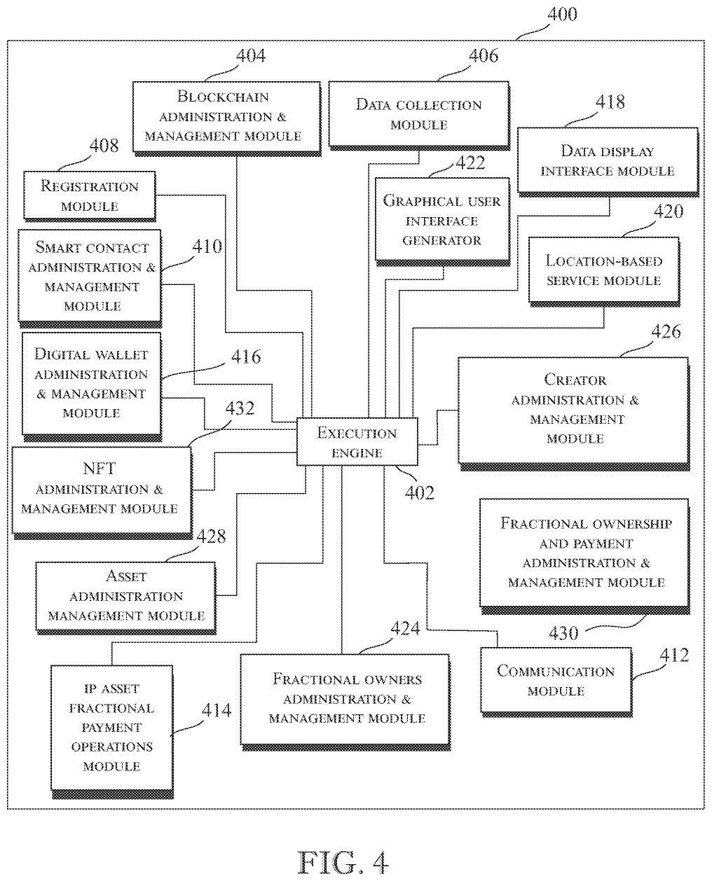

Users may engage with the blockchain-based intellectual property asset fractional payment services offered by and through the cloud network services architecture 100 using an IP asset fractional payment system 200 and/or IP asset fractional payment app 400, as will be detailed herein below, executing on the user device 300. The user device 300 provides users with real-time access to blockchain-based intellectual property asset fractional payment services in accordance with the disclosed embodiments herein. In an embodiment, the blockchain-based intellectual property asset fractional payment processing, offered by and through the cloud network services architecture 100 and the IP asset fractional payment system 200 will be facilitated by the IP asset fractional payment app 400 (see, FIG. 4), as will be detailed herein below, executing on the user device 300 (see, FIG. 3).

As noted above, the cloud 102 comprises at least server(s) 104, the access point(s) 106 and the database(s) 108. Cloud, cloud service, cloud server and cloud database are broad terms and are to be given their ordinary and customary meaning to one of ordinary skill in the art and includes, without limitation, any database, data repository or storage media which store content typically associated with and managed by a user, IP services platforms, blockchains, smart contracts, IP monetization platforms, and third-party content providers in the context of intellectual property assets, to name just a few. A cloud service may include one or more cloud servers and cloud databases that provides for the remote storage of content as hosted by a third-party service provider or operator. A cloud server may include an HTTP/HTTPS server sending and receiving messages in order to provide web-browsing interfaces to client web browsers as well as web services to send data to integrate with other interfaces (e.g., as executed on the user device 300). The cloud server may be implemented in one or more servers and may send and receive content in a various forms and formats, user supplied and/or created information/content and profile/configuration data that may be transferred from or stored in a cloud database (e.g., the databases 108).

A cloud database may include one or more physical servers, databases or storage devices as dictated by the cloud service's storage requirements. The cloud database may further include one or more well-known databases (e.g., an SQL database) or a fixed content storage system to store content, user profile information, configuration information, administration information and any other information necessary to execute the cloud service. In various embodiments, one or more networks providing computing infrastructure on behalf of one or more users may be referred to as a cloud, and resources may include, without limitation, data center resources, applications (e.g., software-as-a-service or platform-as-a-service) and management tools. The term “cloud computing” as referred to herein implies the on-demand availability of computer system resources, especially data storage and computing power, without direct active management by the user. The term is generally used to describe data centers available to many users over the Internet. Large clouds, predominant today, often have functions distributed over multiple locations from central servers. If the connection to the user is relatively close, it may be designated an edge server. Clouds may be limited to a single organization (e.g., enterprise clouds), be available to many organizations (e.g., public cloud), or a combination of both (e.g., hybrid cloud). Cloud computing relies on sharing of resources to achieve coherence and economies of scale. Advocates of public and hybrid clouds note that cloud computing allows companies to avoid or minimize up-front IT infrastructure costs. Proponents also claim that cloud computing allows enterprises to get their applications up and running faster, with improved manageability and less maintenance, and that it enables IT teams to more rapidly adjust resources to meet fluctuating and unpredictable demand.

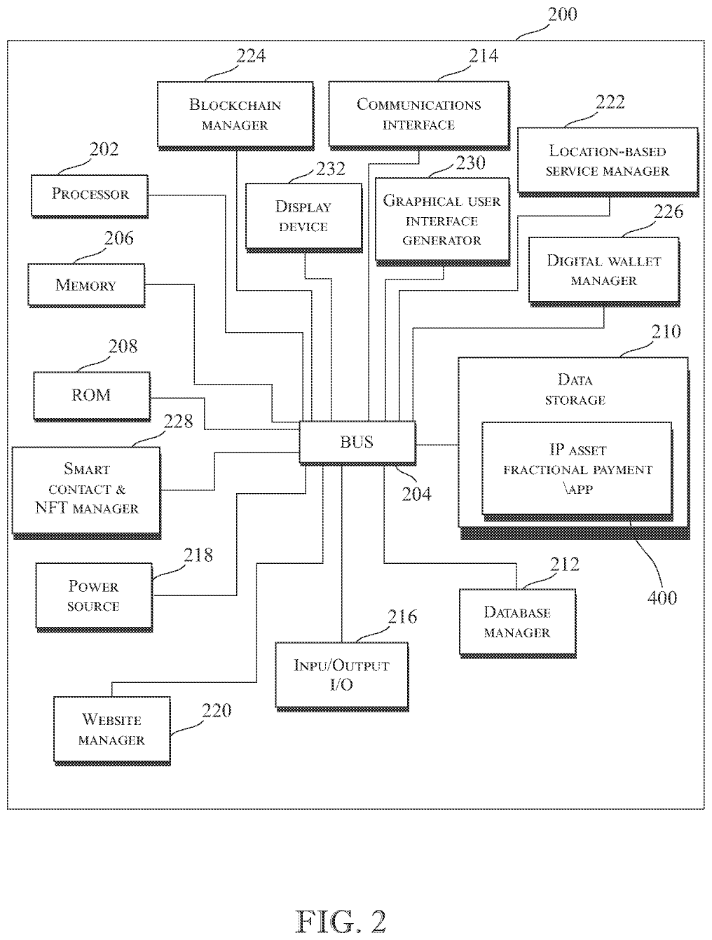

Turning our attention to FIG. 2, an illustrative configuration for the IP asset fractional payment system 200 is shown in accordance with an embodiment. As shown, the IP asset fractional payment system 200 comprises processor 202 for executing program code (e.g., IP asset fractional payment app 400) and communications interface 214 for managing communications to and from the IP asset fractional payment system 200, memory 206 and/or read-only memory (ROM) 208 for storing program code and data, and power source 218 for powering the IP asset fractional payment system 200. The memory 206 is coupled to the bus 204 for storing computer-readable instructions to be executed by the processor 200 (e.g., execution of the IP asset fractional payment app 400). Database manager 212 is used to manage the delivery and storage of content, data, and other information in the database(s) 120 and database(s) 108 and across third-party content providers, for example. The database(s) 120 may store and provide information including, but not limited to, blockchain(s) 122, smart contracts 124, non-fungible tokens 126, fractional ownership and payment information 128, and asset information 130. As will be detailed further herein below, the operations performed by for the IP asset fractional payment system 200 in combination with the IP asset fractional payment app 400, for example, provide for the blockchain-based intellectual property asset fractional payment platform that facilitates sharing a revenue stream generated from an intellectual property asset among individuals having a fractional ownership of the revenue stream generated. In accordance with the embodiment, the computing services platform 134 (see, FIG. 1) provides necessary processing and storage functionality for a blockchain DLT implementation 132 for deployment of smart contracts in accordance with the principles of the disclosed embodiments. As noted above, in an embodiment, the blockchain DLT implementation 132 may be the Hyperledger Fabric made available by the Hyperledger Project. The computer services platform 134 may include a platform such as Amazon Web Services, Microsoft Azure, and Google Cloud computer or any private cloud or non-cloud-based computing platform that parties have access to. A suitable communications network can connect hardware devices on a blockchain comprised of a plurality of blocks. The details of the blockchain and its import to and with the principles of the disclosed embodiments are discussed in greater detail herein below.

Website manager 220 is used to deliver and manage content, data, and other information across one or more websites that may be utilized to access and use the IP asset fractional payment system 200, for example. Further, the operations provided by and through the IP asset fractional payment app 400 may be offered through a web-based application. As will be discussed in greater detail herein below, the IP asset fractional payment app 400, as stored in data storage 210, when executed by the processor 202 will enable access by a plurality of parties to the IP asset fractional payment system 200 for the revenue distribution processing hereunder in accordance with fractional share ownership. Such processing is further enabled by blockchain manager 224, smart contract and NFT manager 228, and digital wallet manager 226. In accordance with an embodiment, the IP monetization may employ cryptocurrency payments to digital wallets in terms of revenue stream payouts or distributions. Digital currency is a currency form that is available in electronic or digital form, but not in physical form. Digital currencies exist and are only accessible with electronic devices, for example, computers and smartphones. That is, digital currencies are intangible and are owned and transacted by using computers or electronic wallets that have access to the Internet 136 or specifically designated computer networks. Digital currencies have all the intrinsic properties of physical currency (e.g., banknotes or minted coins) and allow for instantaneous transactions that are seamlessly executed for making payments across borders and geographic boundaries when the parties are interconnected to supported hardware devices and networks. Cryptocurrencies have emerged as the first generation of blockchain technology. Cryptocurrencies are basically digital currencies that are based on cryptographic techniques and peer-to-peer networks. Today, a number of digital currencies variants, regulated or unregulated, exist such as cryptocurrencies and virtual currencies A cryptocurrency is another form of digital currency that uses cryptography to secure and verify transactions and to manage and control the creation of new currency units. Currently, cryptocurrencies are unregulated so they may also be considered so-called virtual currencies. That is, virtual currencies are an unregulated digital currency that is controlled by its developers, a founding organization, or a defined network protocol. To be clear, the principles of the disclosed embodiments apply equally to any type of digital currency including, but not limited to, a cryptocurrency, a virtual currency, a central bank digital currency (CBDC), and a digital currency electronic payment (DCEP).

Location-based services manager 222 facilitates the delivery of location-based services (e.g., GPS tracking) either independently or on user device 300 thereby allowing the IP asset fractional payment system 200 to register the exact location of the user of the user device 300, for example, as the user roams from one location to another location such that the services offered via the blockchain-based intellectual property asset fractional payment processing hereunder may be tailored to a current location and/or the needs of the user may change based on their current location and a particular social encounter. In an embodiment, the blockchain-based intellectual property asset fractional payment processing provided through the execution of the IP asset fractional payment app 400 may also include a web-based delivery platform and/or accessing and interfacing any number of websites using website manager 220 for procuring information and data that can be used in the IP asset fractional payment system 200. The term “website” in the context herein is used in a conventional and broadest sense and is located on at least one server containing web pages stored thereon and is operational in a 24-hour/7-day typical fashion. Further, as shown in the cloud network services architecture 100, the users may alternatively utilize the well-known Internet 136 for access to IP asset fractional payment system 200 by and through a web browser on the user device 300, for example. The user device 300 may also include one or more input/output devices 216 that enable user interaction with the user device 300 (e.g., camera, display, keyboard, mouse, speakers, microphone, buttons, etc.). The input/output devices may include peripherals, such as an NFC device (e.g., NFC tag reader), camera, printer, scanner (e.g., a QR-code scanner), touchscreen display, etc. For example, the input/output devices 216 may include a display device such as a cathode ray tube (CRT), plasma monitor, liquid crystal display (LCD) monitor or organic light-emitting diode (OLED) monitor for displaying information to the user, a keyboard, and a pointing device such as a mouse or a trackball by which the user can provide input to the user device 300 or an associated display device 232 providing a graphical user interface through graphical user interface generator 230.

The communications interface 214 is used to facilitate communications across the communications links 118 (see, FIG. 1) within the cloud network services architecture 100. This may take the form, for example, of a wide area network connection that communicatively couples the IP asset fractional payment system 200 with the access points 106 (see, FIG. 1) which may be a cellular communications service. Similarly, communications managed by the communications interface 214 may take the form, for example, of a local Wi-Fi network interface or Ethernet interface the communicatively couples the IP asset fractional payment system 200 with the Internet 136, local area network (LAN) 140, and ultimately the user device 300. In the instant embodiment, the IP asset fractional payment app 400 and/or the communications interface 214 may include a communications stack for facilitating communications over the respective communications link 118. Electronic communications by and through IP asset fractional payment system 200 between the various systems, networks, devices, users, entities, and/or individuals are facilitated by the communications links 118 in accordance with any number of well-known communications protocols and methods (e.g., wireless communications).

Turning our attention briefly to FIG. 3, an illustrative user device 300 is shown configured for facilitating intellectual property asset fractional payments in accordance with an embodiment. The user device 300 typically includes bus 302 and processor 304 coupled to the bus 302 for executing operations and processing information. As will be appreciated, a “user device” in the context herein may comprise a wide variety of devices such as any type of hardware device, mobile devices, smartphones, laptop computers, desktop computers, tablets, and wearable devices, to name just a few, that execute applications (e.g., a mobile application) in accordance with the principles of the disclosed embodiments herein. For example, the execution of the IP asset fractional payment app 400 that will be discussed in much greater detail herein below. The processor 304, as powered by power source 312, may include both general and special purpose microprocessors, and may be the sole processor or one of multiple processors of the device. This is equally applicable to the processor 202 of FIG. 2. Further, the processor 304 (or the processor 202) may comprise one or more central processing units (CPUs) and may include, be supplemented by, or incorporated in, one or more application-specific integrated circuits (ASICs) and/or one or more field programmable gate arrays (FPGAs).

The user device 300 may also include memory 306 coupled to the bus 302 for storing computer-readable instructions to be executed by the processor 304. The memory 306 may also be utilized for storing temporary variables or other intermediate information during the execution of the instructions by the processor 304. The user device 300 may also include ROM 308 or other static storage device coupled to the bus 302. Further, data storage device 310, such as a magnetic, optical, or solid-state device may be coupled to the bus 302 for storing information and instructions for the processor 304 including, but not limited to, the IP asset fractional payment app 400. Data storage device 310 (or the data storage device 210) and the memory 306 (and the memory 206) may each comprise a non-transitory computer readable storage medium and may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

The user device 300 may also include one or more communications interface 316 for communicating with other devices via a network (e.g., a wireless communications network) or communications protocol (e.g., Bluetooth®). For example, such communication interfaces may be a receiver, transceiver, or modem for exchanging wired or wireless communications in any number of well-known fashions. For example, the communications interface 316 (or the communications interface 214) may be an integrated services digital network (ISDN) card or modem/router used to facilitate data communications of various well-known types and formats. Further, illustratively, the communications interface 316 (or the communications interface 214) may be a LAN card used to provide data communication connectivity to a comparable LAN. Wireless communication links may also be implemented. The Global Positioning System (GPS) transceiver 318 and antenna 320 facilitate delivery of location-based services in order to register the exact location of the user device 300, for example, as the user roams from one location to another location. As will be understood, the application herein will be able to track individual users upon the launching of the application thereby enabling the well understood GPS location features of the user device 300 (e.g., a smartphone).

As will be appreciated, the functionality of the communication interface 316 (or the communications interface 214) is to send and receive a variety of signals (e.g., electrical, optical, or other signals) that transmit data streams representing various data types. The user device 300 may also include one or more input/output devices 314 that enable user interaction with the user device 300 such as a camera, display, keyboard, mouse, speakers, microphone, buttons, etc. The input/output devices 314 (or I/O devices 216) may include peripherals, such as an NFC device (e.g., NFC reader), camera, printer, scanner (e.g., QR-code scanner), touchscreen display, etc. For example, the input/output devices 314 (or the I/O devices 216) may include a display device such as a cathode ray tube (CRT), plasma monitor, liquid crystal display (LCD) monitor or organic light-emitting diode (OLED) monitor for displaying information to the user, a keyboard, and a pointing device such as a mouse or a trackball by which the user can provide input to the user device 300 or an associated display device, for example.

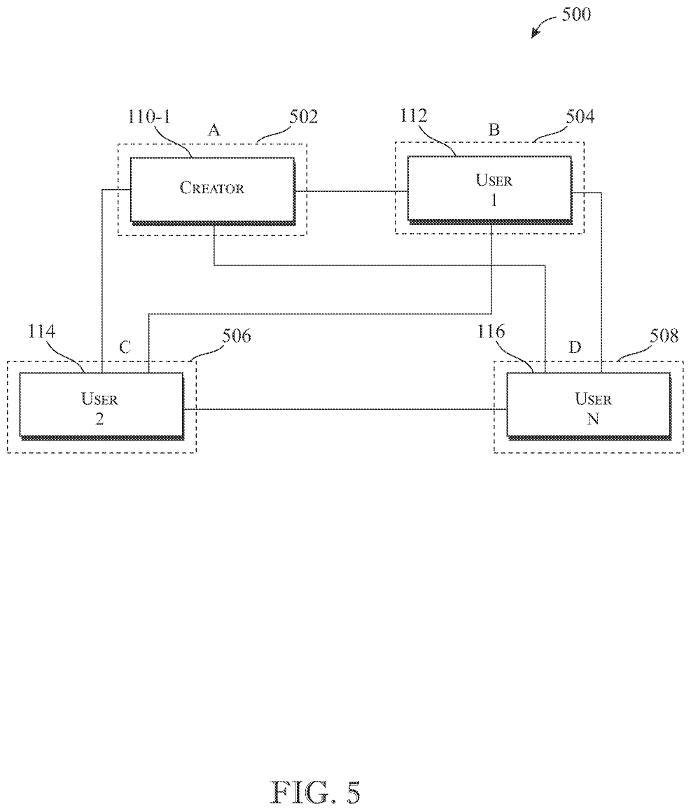

Turning our attention to FIG. 5, an illustrative mesh network 500 is shown between various parties for engaging in blockchain-based intellectual property asset fractional payments in accordance with an embodiment. As shown, the illustrative mesh network 500 employs a peer-to-peer configuration that includes four (4) nodes between a plurality of parties. In particular, with reference to certain of the parties of the instant embodiments, node A 502 associated with the creator 1 110-1, node B 504 associated with the user 1 112, node C 506 associated with the user 2 114, and node D 508 associated with the user N 116. The illustrative mesh network 500 is configured such that each node can communicate with and relay data to each of the other nodes. In this way, the various parties may use their respective user devices (e.g., the user device 300) to communicate with each other across the mesh network 500 in performing the various operations and/or actions required by the IP asset fractional payment system 200 and associated intellectual property asset fractional payment processing Of course, the illustrative configuration shown in FIG. 5 is only one of many different possibilities that may be utilized to deploy the smart contracts across the DLT technology in accordance with the principles of the disclosed embodiments. The parties associated with the defined and deployed smart contract and associated fractional ownership and revenue stream distributions do not need to know each other. Further, deployment of the smart contract 124 herein ensures the security and authentication of the revenue stream distribution plan in that the decentralized and global structure of the blockchain, for example, will guarantee the identity and association of the third parties and their fractional ownership.

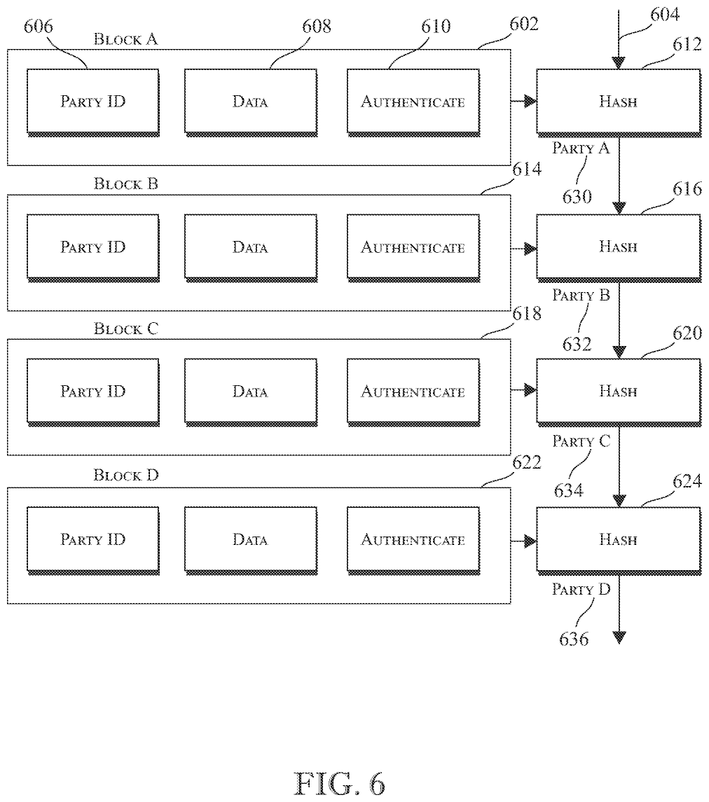

As noted above, in the framework of the principles of the disclosed embodiments, a blockchain is a public ledger of all transactions that have been executed in a particular context (e.g., the IP monetization processing hereunder). The blockchain constantly enlarges as completed blocks are added thereto as new transactions are addressed. Typically, blocks are added to the blockchain (see, e.g., blockchain 604 in FIG. 6) in a linear, chronological order by the various user devices involved in the transaction(s) and are interconnected in executing the blockchain protocol, for example, in a peer-to-peer network. The peer-to-peer network is essentially a plurality of interconnected nodes (e.g., node A 502, node B 504, node C 506, and node D 508) with each node associated with a particular user device the employs a client to validated and relay transactions (e.g., one of the relevant transactions specific to the intellectual property asset fractional payments processing hereunder). In an embodiment, a copy of the blockchain is maintained by each node which is automatically downloaded to the node upon joining the blockchain. In turn, the blockchain protocol provides a secure and reliable mechanism for updating and distributing copies of the blockchain across the interconnected nodes.

Turning our attention to FIG. 6, an illustrative intellectual property asset fractional payment blockchain interaction between various parties is shown using the IP asset fractional payment system 200 in accordance with an embodiment. As illustrated, the blockchain 604 is distributed among multiple devices (i.e., the user device 300 associated with each party, see, e.g., FIG. 1) associated with multiple parties. For example, party A 630 (the creator party 1 110-1), party B 632 (the user 1 112), party C 634 (the user 2 114), and party D 636 (the user N 116. In the example shown, block A 602 is added to the blockchain 604 and may contain party ID 606 of party A 630 or an address/identification of the user device 300 associated and used by the party A 630, and may also contain data 608 (e.g., relevant intellectual property asset fractional payment data). Also, the block A 602 may contain an authentication portion 610 that may be used to set restrictions of various levels on the data 608 and/or the party ID 606. For example, the party ID 606 and the data 608 may be set such that they are not accessible to one or more of the other parties. This may be advantageous if the creator 1 110-1, for example, does not want the user N 116, for example, to have access to certain of the data 608.

The data 608 may be part of one of the smart contracts 124 employed by the IP asset fractional payment system 200 and associated operations enabling the intellectual property asset fractional payments processing hereunder. In turn, the smart contract 124 is stored on the blockchain 604 and executed automatically as part of the respective transactions executed. As the user device 300 generates the block 602, the block 602 is hashed 612 into the previous blockchain 604 resulting in an updated blockchain 604 which continues to be distributed among the various parties and their respective user devices. The blockchain protocol includes a so-called proof of work scheme that is based on a cryptographic hash function (CHF), for example, the secure hash algorithm 256 (SHA-256). Generally, the CHF receives information as input and provides a hash value output, wherein the hash value has a predetermined length. For example, SHA-256 provides a 256-bit (32-byte, 64 character) hash value output The blockchain may also require multiple information pieces as input to the CHF. The input, for example, may include a reference to the previous (i.e., most recent) block in the blockchain, details of the transaction(s) that are to be included in the to-be-created block, and a nonce value (e.g., a random number used a single time). Further, the blockchain protocol provides a threshold hash to qualify a block to be added to the blockchain. For example, the threshold hash may include a predefined number of zeros (0's) that the hash value must have at the start, and the higher the number the more effort that is required to arrive at the qualifying hash. The other user devices 300 receive the updated blockchain 604 containing the block 602. Illustratively, party B 632 receives the blockchain 604 and generates block B 614 and store the respective data in the blockchain 604. Similar to block A 602, the block B 614 may store the respective transaction data of the party B 632, an ID of the party B 632, or an address/identification of their respective user device 300, and an authentication portion. As the block B 614 is generated the block is hashed 616 into the previous blockchain 604 resulting in an updated blockchain which is distributed among the respective user devices 300 of the various parties. In turn, the party C 634 may generate block C 618 in their transaction processing which is subsequently hashed 620 into the blockchain 604 which again results in an updated blockchain that is distributed among the respective user devices 300 of the various parties in the intellectual property asset fractional payments processing. Accordingly, similar to the parties A, B, and C, party D 636 may generate block D 622 that is hashed (i.e., hash 624) into the blockchain 604 which results in a further updated blockchain that is distributed to the respective use devices 300 of the various engaged parties.

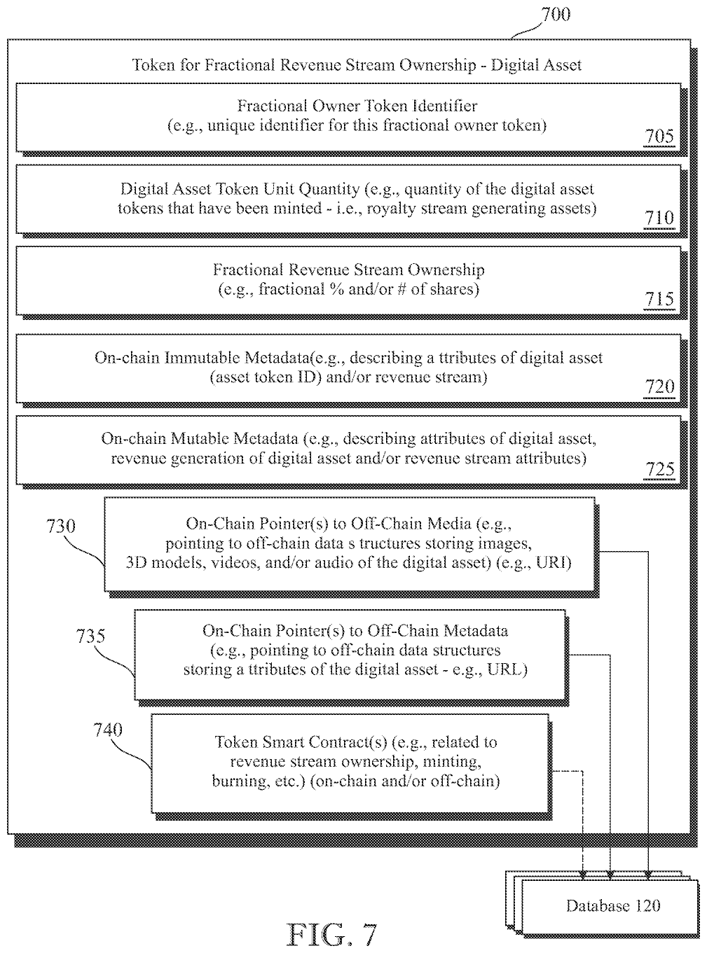

Turning our attention to FIG. 7, a block diagram illustrating an example fractional owner token 700 (hereinafter referred to as the “token”) that can be non-fungible and that can represent a fractional ownership digital asset for engaging in blockchain-based intellectual property asset fractional payments in accordance with an embodiment. The token 700 can be non-fungible and that can represent the fractional ownership shares issued a third party in a revenue stream generated from an intellectual property asset created by the intellectual property asset owner as tracked in a distributed ledger, according to an aspect of the present disclosure. In some examples, the token 700 is an NFT. In some examples, the token 700 is an ERC721 token, an ERC1155 token, an ERC-20 token, or a combination thereof. In some examples, the token 700 is tracked in a blockchain ledger (e.g., the blockchain 604). In some examples, the token 700 is tracked in an Ethereum-based blockchain ledger. One or more token smart contracts 740 can be associated with the token 700. For instance, the one or more token smart contracts 740 manage creation (or “minting”) of the token 700. The one or more token smart contracts 740 can pay miner devices that create (“mint”) a token 700, or batches of tokens, for computing time and resources taken to mint the token 700. The one or more token smart contracts 740 can control how ownership of the token 700 is decided and/or transferred. For instance, the one or more token smart contracts 740 (such as one of the smart contracts 124 of FIG. 1) can indicate an initial owner of the token 700 and/or can identify conditions under which ownership automatically transfers or expires.

The one or more token smart contracts 740 can indicate conditions under which the token 700 may be transferred. The one or more token smart contracts 740 can control conditions under which the token 700 can be burnt, or irreversibly destroyed and/or unlisted. The illustrative elements identified as part of the token 700 include fractional owner token identifier 705 (e.g., a unique identifier for this token 700), digital asset token unit quantity 710 (e.g., quantity of the tokens 700 that have been minted); that is, the revenue stream generating assets associated with the particular intellectual property asset), fractional revenue stream ownership 715 (e.g., factional percentage (%) and/or number of fractional shares), on-chain immutable metadata 720 (e.g., describing attributes of the intellectual property assets and/or the associated revenue stream generated from the intellectual property assets), on-chain mutable metadata 725 (describing attributes of the intellectual property asset, the associated revenue generation from the intellectual property asset, and/or the revenue stream attributes), on-chain pointers to off-chain media 730 (e.g., pointing to off-chain data structures, images, models, videos audio and/or our URL links associated with the intellectual property asset), on-chain pointers to off-chain metadata 735 (e.g., pointing to off-chain data structures storing attributes associated with the intellectual property assets). The on-chain pointers to the off-chain metadata can be stored as part of the token 700, can be part of the token smart contracts 740, or both. In some examples, the code of the token smart contracts 740 is stored at least partly on-chain. In some examples, the code of the token smart contracts 740 is stored at least partly off-chain at off-chain location(s) such as the databases 120, with the off-chain location(s) identified by on-chain pointers to the off-chain location(s). The token 700 includes token identifier 705, which may be referred to as a tokenID. The token identifier 705 can be a unique identifier for the token 700 and may also be associated with the intellectual property assets, as desired. The token identifier 705 can be used to distinguish the particular instance of the fractional share(s) that the token 700 corresponds to from any other instance of the fractional shares.

In some examples, token identifiers can be generated by the IP asset fractional payment system 200 creating (or “minting”) the token 700 by incremented sequentially compared to token identifiers of previously created tokens, to ensure that each token identifier is unique. The token 700 can include the digital asset token unit quantity 710. The digital asset token unit quantity 710 can identify a quantity of the token 700 that has been or is set to be minted. In some examples, the digital asset token unit quantity 710 may be one (1), in which case a single token 700 exists for a given revenue stream generated by the intellectual property assets. In some examples the digital asset token unit quantity 710 is greater than one. For example, if the digital asset token unit quantity 710 is one hundred (100), then there are effectively 100 copies of this token 700 representing the fractional ownership in the given revenue stream generated by the intellectual property asset that can be owned, fractionalized, and/or transferred separately. Those copies may be fungible between one another, or indistinguishable from one another. However, those copies are still non-fungible, unique, distinct, and/or distinguishable relative to any other instance or version or variant associated with the revenue stream. The digital asset token unit quantity 710 can control how rare or valuable the token 700 is, and by extension the revenue stream generated from the intellectual property asset. If the digital asset token unit quantity 710 is one, (1) then the token 700 is unique. In some examples, there may be any number of ranges of fractional shares associated with the generated revenue stream of the intellectual property assets depending upon whether users choose to further fractionalize their owned fractional shares or not. In some cases, the digital asset token unit quantity 710 may be specified as part of the minting process and/or identified in one of the token smart contracts 740 that manages the minting process. The token 700 may identify the fractional revenue stream ownership 715, which may identify who owns the token 700, and by extension, the sharing in the revenue stream generated by the intellectual property asset. The fractional revenue stream ownership 715 may initially be assigned to a creator of the intellectual property asset. The token smart contracts 740 can control rules for transfer of token ownership and the fractionalizing of shares fractional revenue stream ownership 715 can be transferred as a transaction that is recorded as a payload element in a payload of a block of a blockchain ledger or another distributed ledger. In this way, the original creator of the intellectual property asset and/or the IP owner may earn a royalty or other compensation automatically upon any resale, in whole or in part, of any fraction derived from their original fractional shares.

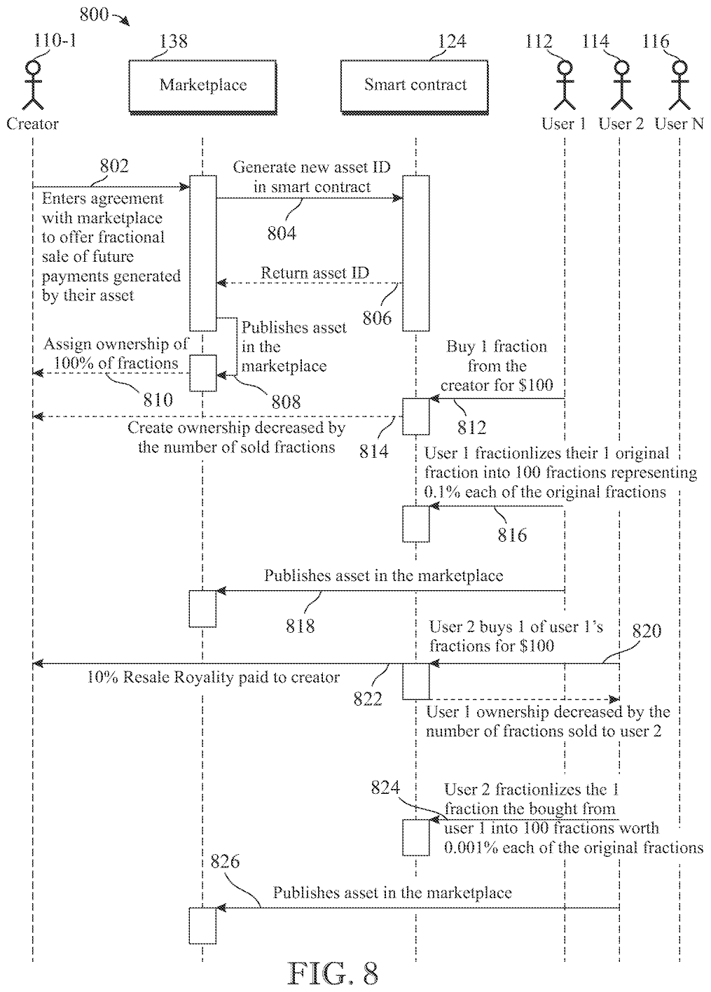

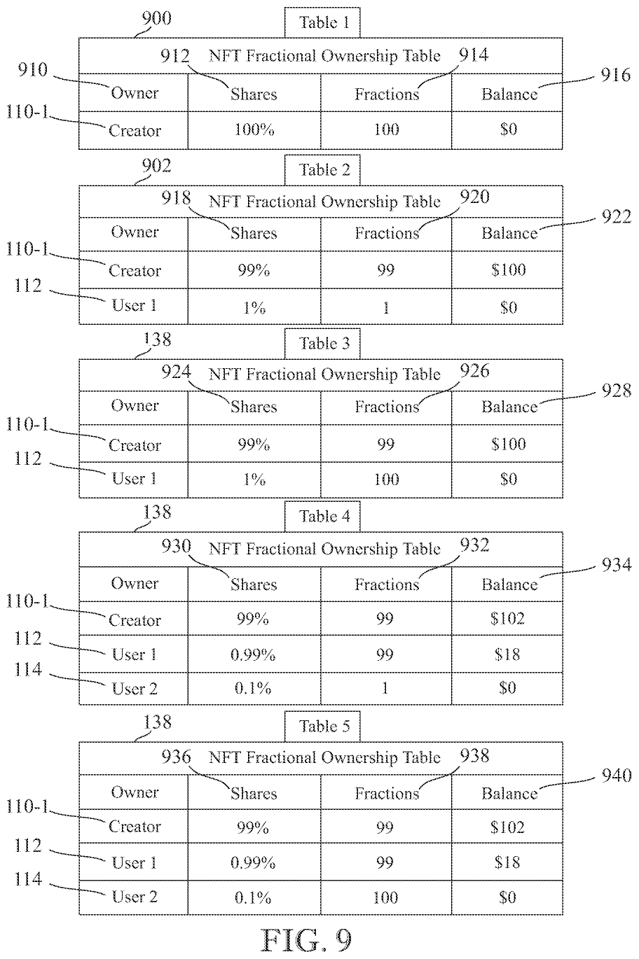

Turning our attention to FIGS. 8 and 9 that will be discussed together, FIG. 8 presents an exemplary operational and data flow diagram 800 illustrating operations that occur during intellectual property asset fractional payment transactions in accordance with an embodiment, and FIG. 9 presents a series of NFT fractional ownership examples between an intellectual property creator and third parties resulting from the intellectual property asset fractional payment transactions of FIG. 8. More particularly, creator 110-1 has created an intellectual property asset (e.g., a digital song) that will be generating a revenue stream (e.g., copyright royalties). As such, at 802, the creator 110-1 will enter into an agreement by and through the marketplace 138 (see, FIG. 1) to offer fractional shares in the future revenue stream generated from the intellectual property asset. Illustratively, establishing a smart contract (e.g., the smart contract 124) on a DLT governing an agreement by an intellectual property asset owner to offer fractional ownership shares to a plurality of third parties in revenue generated from the intellectual property asset created by the intellectual property asset owner. Importantly, each fractional ownership share offered entitles any one of third parties to receive a portion of the revenue stream generated from the intellectual property asset commensurate with a number of fractional ownership shares owned by the third party (e.g., the user 1 112, the user 2 114, and the user N 116). That is, the individual fractional ownership shares represented by the NFTs are employed for the intellectual property creator and other third parties to share in the revenue stream generated from the intellectual property asset and to actively buy and sell the individual fractional ownership shares. Each fractional share is uniquely identifiable and may be traced to the original fractional share from which it was derived. In an embodiment, fractional ownership includes one hundred percent (100%) of all shares held by a single individual or entity, and the fractional ownership offered by the IP asset owner (or IP asset creator) may include a single share representing one hundred percent (100%) of all shares (i.e., a “1 for 1” offering). Again, as noted previously, it will be understood that the IP asset creator is the individual who created the IP asset (i.e., the IP asset creator). Alternatively, an IP owner is an individual who is the current owner of the IP asset (e.g., having received an ownership interest, in whole or in part, in the IP asset from the IP creator and/or another IP owner). Thus, the IP asset creator may also be the IP owner and the IP owner may not necessarily be the IP asset creator, depending upon the context.

At 804, a request is generated for a new/unique asset identification code specific to the intellectual property asset. The unique asset identification code is ideally a digital identifier that may be embedded into the intellectual property asset (e.g., a digital music file) to facilitate a tracking of the asset and report revenue generating activities (e.g., the playing of a song across different digital music platforms that are subject to royalty requirements). In an embodiment, the embedded asset identification may be in a format specified by the International Standard Recording Code (ISRC) system which is an internationally recognized system for the identification of recorded music and music videos. Each ISRC is a unique and permanent identifier for a specific recording, independent of the format on which it appears (e.g., compact discs, audio files, etc.) or the rights holders involved. Only one ISRC should be issued to a track, and an ISRC can never represent more than one unique recording. Thus, to facilitate payments to fractional owners the blockchain asset identification (ID) may be connected, associated, or otherwise linked (e.g., digitally linked) to the intellectual property asset that generates the revenue stream to be distributed to the fractional owners via the IP asset fractional payment system 200, for example. The blockchain asset ID may be embedded in the metadata of the intellectual property asset so that revenue and payments derived from the intellectual property asset are inextricably linked to the blockchain asset ID which if further linked to the each individual NFT representing fractional ownership in the generated revenue stream.

At 806, the asset identification code is generated and specified in the smart contract 124 (see also, smart contracts 740). Illustratively, by assigning using the smart contract an asset identification code specific to the intellectual property asset. This will enable for a tracking of the intellectual property asset and the revenue stream generated therefrom which will be distributed in whole or in part to the creator 110-1 and/or the user 1 112, the user 2 114, and the user N 116 in accordance with fractional ownership shares held thereby. At 808, the intellectual property asset is published on the marketplace 138 by the creator 1 110-1 with one hundred percent (100%) of fractional shares assigned, at 810, to the creator 1 110-1 and owned thereby. The publication on the marketplace 138 may also specify the number of fractional shares owned by the creator 1 110-1 that are available for sale and transfer to third parties. The smart contract 124 will trigger the creation and minting of NFTs such that each NFT will represent a fractional share to be offered for sale. Illustratively, minting a NFT for tokenizing each individual fractional ownership share of the initial number of fractional ownership shares offered for sale. Illustratively, assigning a first fractional ownership percentage in accordance with the initial number of fractional ownership shares offered for sale and issuing to the intellectual property asset owner a first digital key comprising the first fractional ownership percentage assigned. Thus, at the outset and as shown in Table 1 900 of FIG. 9 the NFT fractional ownership rests entirely with the creator 1 110-1 (also owner 910) having shares 912 at one hundred percent (100%), fractions 914 at one hundred (100), and a balance 916 of zero (0) U.S. dollars as no revenue stream has yet been generated from the intellectual property asset. In an aspect, the smart contract 124 may also specify a term for how long fractional shares may be available and on what date ownership of fractional shares revert back to the creator 1 110-1. Further, the first digital key will be updated over time in accordance with fractional share purchase/sale activities. All subsequent owners are also issued a unique digital key which is updated according to fractional share purchase/sale history. Illustratively, there is responsive to the purchasing request received from the first third party, assigning a second fractional ownership percentage in accordance with specific number of fractional ownership shares specified in the purchasing request received, issuing a second digital key to the first thirst party comprising the second fractional ownership percentage assigned, adjusting the first fractional ownership percentage assigned by decreasing the first fractional ownership percentage by the second fractional ownership percentage assigned, and updating the first digital key issued with the first fractional ownership percentage adjusted.

At 812, the user 1 112 decides to purchase one (1) fractional share from the creator 1 110-1 for one hundred (100) U.S. dollars as per the publication on the marketplace 138. This decreases, at 814, the fractional share ownership of the creator 1 110-1 by the number of fractional shares sold as reflected in Table 2 902 whereby the NFT fractional ownership of the creator 1 110-1 is now the number of shares 918 at ninety-nine percent (99%), fractions 920 at ninety-nine (99), and a balance 922 of one hundred U.S. dollars ($100.00) in view of the fractional shared sold to the user 1 112. The user 1 112 having shares 918 at one percent (1%), fractions 920 at one (1), and a balance 922 of zero (0) U.S. dollars. Now, in accordance with the principles of the disclosed embodiments, the user 1 112 decides, at 816, to fractionalize their current fraction of one (1) into multiple fractions. For example, one hundred (100) fractions each representing 0.1 percent (0.1%) of the original fractions. Illustratively, receiving from the intellectual property asset owner an identification of an initial number of fractional ownership shares offered for sale to a plurality of third parties. As reflected in Table 3 904, the NFT fractional ownership of the creator 1 110-1 remains at the number of shares 924 at ninety-nine percent (99%), fractions 926 at ninety-nine (99), and a balance 928 of one hundred U.S. dollars ($100.00). The user 1 112 having shares 924 at one percent (1%), fractions 926 at one hundred (100), and a balance 928 of zero (0) U.S. dollars. At 818, the user 1 112 publishes the availability of these available fractional shares (i.e., an asset) on the marketplace 138. At 820, user 2 114 purchases one (1) share of the available fractional shares posted by user 1 112 on the marketplace 138 for twenty U.S. dollars ($20.00). This sale further triggers, at 822, a fractional share resale royalty back to the creator 1 110-1 of ten percent (10%) and decreases the fractional share ownership of user 1 112 by the number of fractions sold to user 2 114. As reflected in Table 4 906 the NFT fractional ownership of the creator 1 110-1 remains at the number of shares 930 at ninety-nine percent (99%), fractions 932 at ninety-nine (99), but the balance 934 is now one hundred two (102) U.S. dollars in view of the fractional shares sold by the user 1 112 to the user 2 114 and the royalty payment to the creator 1 110-1. The user 1 112 having shares 930 at ninety-nine percent (99%), fractions 932 at ninety-nine (99), and a balance 934 of eighteen U.S. dollars ($18.00) reflecting the net balance after payment of the royalty to the creator 1 110-1. The user 2 114 having shares 930 at 0.1 percent (0.1%), fractions 932 at 1 (1), and a balance 934 of zero U.S. dollars ($0.00).

Now, the user 2 114 decides, at 824, to fractionalize their current fraction of one (1) into multiple fractions. For example, one hundred (100) fractions each representing 0.001 percent (0.001%) of the original fractions made available. At 826, the user 2 114 publishes the availability of these available fractional shares on the marketplace 138. As reflected in Table 5 908, the NFT fractional ownership of the creator 1 110-1 remains at the number of shares 936 at ninety-nine percent (99%), fractions 938 at ninety-nine (99), and a balance 940 of one hundred two U.S. dollars ($102.00). The user 1 112 having shares 936 at 0.99 percent (0.99%), fractions 938 at ninety-nine (99), and a balance 940 of eighteen U.S. dollars ($18.00), and the user 2 114 having shares 936 at 0.1 percent (0.1%), fractions 938 at one hundred (100), and balance 940 at zero (0) U.S. dollars.

Thus, in accordance with principles of the disclosed embodiments, fractional sales may continue for an unlimited number of fractions to an unlimited number of parties. Further, the entirety of the fractional share transactions and associated payments may occur on a completely anonymous basis unless the involved parties prefer otherwise. As detailed herein, central to these operations is the use of a centralized database for collecting and distributing payments, a decentralized ledger the records the transaction history, an immutable contract specifying and delivering the terms of fractional payment distributions, one or more user devices (e.g., a mobile device), and an intellectual property asset that holds potential to generate a revenue stream.

The disclosed embodiments herein contemplate a subscription-based service for use by the users but may also be used in a non-subscribed platform. As such, a user request (e.g., the creator 1 110-1) may be received and a determination made if a user is a new or returning user. If a new user, then a determination is made as to whether the user is a subscriber or not (e.g., in accordance with a user agreement and/or user privacy/security agreement). If not, then the new user is subscribed, and a user profile is created and the user profile is stored. Illustratively, the user profile will be used in various embodiments to assist with the smart contract creation and deployment thereof. If the user declines to become a subscriber, then they may proceed as a non-subscriber and will enter a temporary user profile which will be stored. If the user is a returning user (or one of the newly subscribed users or new non-subscribed user), their identity is authenticated using, for example, a two-factor authentication (e.g., a text message to the user device 300). If not authenticated, then the operations end. If they are authenticated, then their respective user profile is retrieved. A determination is made as to whether any updates to the user profile are desired and if so, the updated are received and the updated user profile stored.

Turning our attention back to FIG. 4, an illustrative architecture for the operation of the IP asset fractional payment app 400 is presented in accordance with an embodiment. As will be appreciated, the architecture may be used, illustratively, in conjunction with the cloud network services architecture 100, the IP asset fractional payment system 200, and/or the user device 300 for launching and executing the IP asset fractional payment app 400 and its associated operations (as detailed herein above). As shown, the architecture for the operations of the IP asset fractional payment app 400 provides several interfaces and engines used to perform a variety of functions such as the collection, aggregation, manipulation, processing, analyzing, verification, authentication, and display of applicable real-time information and data that are useful to realize the delivery of the intellectual property asset fractional payment operations of the disclosed embodiments. More particularly, data display interface module 418 and communications module 412 are used to facilitate the input/output and display of electronic data and other information to, illustratively, the users (e.g., the creator 1 110-1 and the user 2 114) employing the user device 300 (e.g., a touch screen of the user device 300) and executing the IP asset fractional payment app 400. The data collection module 406 facilitates data gathering from a plurality of users and other third parties. The location-based services module 420 provides for the delivery of location-based services in order for the geographic locations of the users to be identified and displayed (e.g., GPS locations) in accordance with any proximity-based features of the disclosed embodiments. The communications module 412 will also facilitate communications by and through the IP asset fractional payment system 200, for example.

Execution engine 402 may be employed to deliver the IP asset fractional payment services herein through the execution of the IP asset fractional payment app 400. In such delivery, the execution engine 402 will operate and execute, as further detailed herein below, with at least the following program modules: blockchain administration and management module 404, data collection module 406, registration module 408, smart contract administration and management module 410, communications module 412, IP asset fractional payment operations module 414, digital wallet administration and management module 416, graphical user interface module 422, fractional owners administration and management module 424, creator administration and management module 426, asset administration and management module 428, fractional ownership and payment administration and management module 430, and NFT administration and management module 432. The registration module 408 provides for the delivery and management of a subscription-based IP asset fractional payment services model (as detailed previously) whereby individual users (e.g., the creator 1 110-1) subscribe in order to access the IP asset fractional payment services through execution of the IP asset fractional payment app 400. In an embodiment, the user may initially subscribe, as facilitated by the registration module 408 for a defined fee in a tier subscription system such that users who pay more for their access subscription are provided priority and other advantages over other users in lower tiers or who are subscribed through a base “no fee” trial plan (e.g., a free 30 day trial period). The registration module 408 will also provide for the creation and maintenance of individual user profiles for each subscribed user in conjunction with the various party modules. Further, in an embodiment, the data display interface module 418, and the communications module 412 are used to facilitate the input/output and display of electronic data and other information (e.g., a graphical user interface) to, illustratively, the users employing the user device 300 (e.g., a touch screen of the mobile device 200) and executing the IP asset fractional payment app 400. The data collection module 406 facilitates IP asset fractional payment services information collection from the various parties involved in defining, deploying and/or executing the smart contract 124 hereunder. The data collection module 406 may also be used to collect a variety of information (e.g., personal information, photographs, IP asset licenses, etc.) information from other virtual and/or electronic sources accessible via the Internet 136 and individual third party websites hosted thereon. The operations executed by each and every of the foregoing modules are, for example, as discussed throughout this disclosure.

Those skilled in the art will appreciate that the present disclosure contemplates the use of systems configurations and/or computer instructions that may perform any or all of the operations involved in IP asset fractional payments. The disclosure of computer instructions that include, for example, the intellectual property asset fractional payment app 400 and the intellectual property asset fractional payment system 200 is not meant to be limiting in any way. Those skilled in the art will readily appreciate that stored computer instructions and/or systems configurations may be configured in any way while still accomplishing the various goals, features, and advantages according to the present disclosure. The terms “program,” “application,” “software application,” and the like as used herein, are defined as a sequence of instructions designed for execution on a computer system. A “program,” “computer program,” “application,” or “software application” may include a subroutine, a function, a procedure, an object method, an object implementation, an executable application, an applet, a servlet, a source code, an object code, a shared library/dynamic load library, and/or other sequence of instructions designed for execution on a computer system. The disclosed embodiments and their principles may be described in the general context of computer code or machine-useable instructions, including computer-executable instructions such as program modules, being executed by a computer, processor or other machine, such as a smartphone or other handheld device. Generally, program modules including routines, programs, objects, components, data structures, etc., refer to code that perform particular tasks or implement particular abstract data types. The embodiments may be practiced in a variety of system configurations, including, but not limited to, mobile devices, consumer electronics, general-purpose computers, and specialty computing devices. Further, the embodiments may also be practiced in distributed computing environments where tasks are performed by remote-processing devices that are linked through a communications network. Accordingly, applications herein may be written using any number of programming languages and/or executed on compatible platforms including, but not limited to, JavaScript, PHP (PHP: Hypertext Preprocessor), WordPress, Drupal, Laravel, React.js, Angular.js, and Vue.js. Computer readable program instructions for carrying out operations of the disclosed embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on one or more standalone computers, partly on one or more standalone computers, as a stand-alone software package, partly on one or more standalone computers and partly on one or more remote computers, partly on one or more standalone computers and partly on one or more distributed computing environments (such as a cloud environment), partly on one or more remote computers and partly on one or more distributed computing environments, entirely on one or more remote computers or servers, or entirely on one or more distributed computing environments. Standalone computers, remote computers, and distributed computing environments may be connected to each other through any type of network or combination of networks, including local area networks (LANs), wide area networks (WANs), through the Internet (e.g., using an Internet Service Provider), or the connection may be made to external computers.

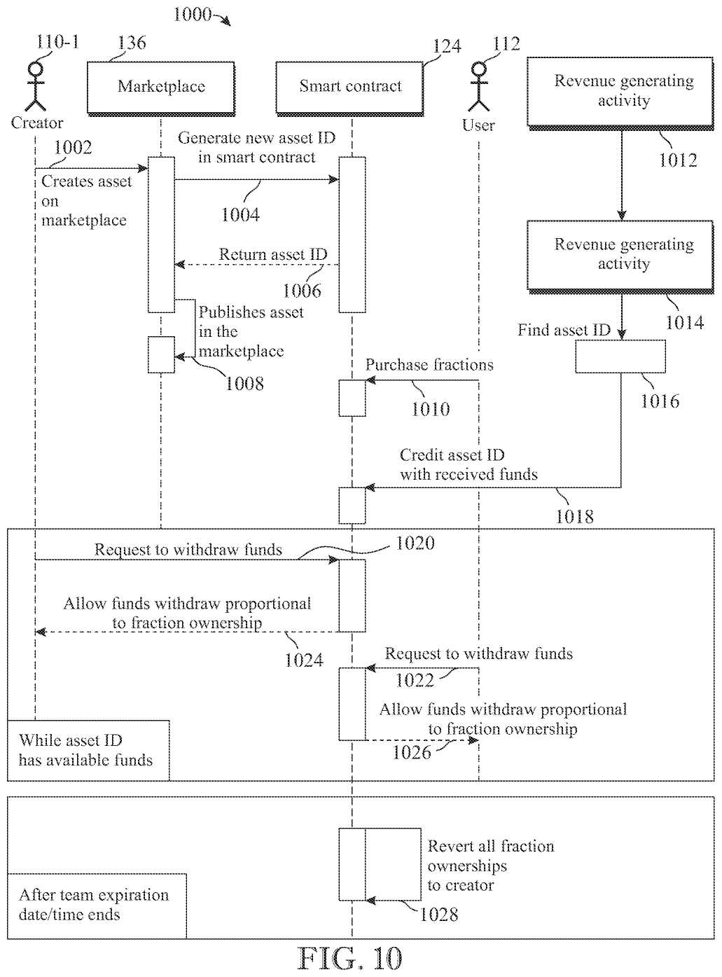

Turning our attention to FIG. 10, an exemplary operational and data flow diagram 1000 is shown illustrating operations that occur during intellectual property asset fractional payment transactions that include fund withdrawals in accordance with an embodiment. That is, in accordance with this embodiment, the creator and/or third parties may request and withdraw any accumulated funds garnered from their IP fractional share ownership in the revenue stream generated by an intellectual property asset. Similar to as detailed above, at 1002 creator 1 110-1 has created an intellectual property asset (e.g., a digital song) that will be generating a revenue stream (i.e., revenue generating activity 1012). As such, at 1004, the creator 110-1 will enter into an agreement (e.g., smart contract 124) by and through the marketplace 138 to offer fractional shares in the revenue generating activity 1012 generated from the intellectual property asset and a request is generated for a new/unique asset identification code specific to the intellectual property asset. At 1006, the asset identification code is generated and specified in the smart contract. At 1008, the intellectual property asset is published on the marketplace 138 by the creator 1 110-1 with one hundred percent (100%) of fractional shares assigned to the creator 1 110-1. The publication on the marketplace 138 may also specify the number of fractional shares owned by the creator 1 110-1 that are available for sale and transfer to third parties. The smart contract 124 will trigger the creation and minting of NFTs such that each NFT will represent a fractional share to be offered for sale. Illustratively, minting a NFT for tokenizing each individual fractional ownership share of the initial number of fractional ownership shares offered for sale Illustratively, assigning a first fractional ownership percentage in accordance with the initial number of fractional ownership shares offered for sale and issuing to the intellectual property asset owner a first digital key comprising the first fractional ownership percentage assigned. This first digital key will be updated over time in accordance with fractional share purchase/sale activities. All subsequent owners are also issued a unique digital key which is updated according to fractional share purchase/sale history.

At 1010, the user 1 112 decides to purchase one or more fractional shares as per the publication on the marketplace 138. This decreases the fractional share ownership of the creator 1 110-1 by the number of fractional shares. As revenue is generated in accordance with the revenue generated activity (e.g., the licensing of the intellectual property asset for a defined royalty) the funds are received at 1014 and attributed to the intellectual property asset in accordance with the asset identification code specific thereto. At 1016, a search may be performed to locate the record associated with the intellectual property (e.g., as stored in the database(s) 120 in the asset information 130) and the record updated and credited with the received funds at 1018. These received funds are then distributed to the creator and/or the third parties in accordance with the fractional shares they individually hold, as detailed above. Now, at 1020 and 1022 the creator 1 110-1 and the user 1 112 each decide they wish to withdraw certain of their respective accumulated funds. Thus, at 1024 and 1026 received funds are allowed to be withdrawn in proportion to the fractional share ownership of the creator 1 110-1 and the user 1 112, respectively, as governed by the smart contract 124. As noted above, the creator has the option to define a term in the smart contract 124 that will govern a period of time that fractional shares may be outstanding and when, upon expiration of the term, that all fractional shares revert back to the creator. In the current example, if the smart contract 124 includes such a term, then at 1028 all the fractional shares revert back to the creator 1 110-1.

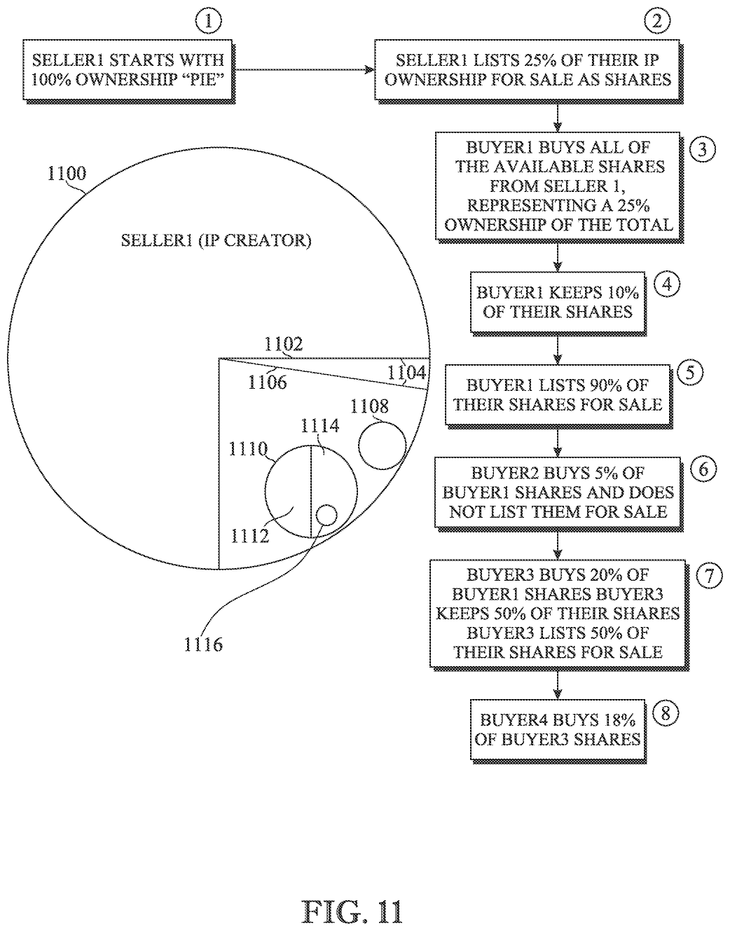

Turning our attention to FIG. 11, a flow and fractional shares diagram is shown outlining one example of intellectual property asset fractional payment transactional processing in accordance with an embodiment. As depicted, Seller1 begins with one hundred percent (100%) fractional share ownership (i.e., fractional shares 1100) of an IP asset's associated revenue stream at block 1 and decides to later list twenty-five percent (25%) thereof (i.e., fractional shares 1102) at block 2. Thereafter, Buyer1 purchases, at block 3, the entire fractional shares 1102 listed by Seller1 (i.e., the 25% of the fractional shares 1100) and Buyer1 decides to keep ten percent (10%) (i.e., fractional shares 1104) at block 4 and list the other ninety percent (90%) of their fractional shares 1104 for sale (i.e., fractional shares 1106) at block 5. Then, Buyer2 purchases at block 6 five percent (5%) of the fractional shares 1106 listed for sale by Buyer1 as shown by fractional shares 1108 and Buyer2 retains full ownership thereof and does not list their fractional shares 1108 for sale. Buyer3 purchases twenty percent (20%) of the fractional sales 1106 of Buyer1 (i.e., fractional sales 1110) at block 7 and keeps fifty percent (50%) of the fractional sales 1110 and lists fifty percent (50%) for sale (i.e., fractional shares 1112 and fractional shares 1114, respectively). Finally, at block 8, Buyer4 purchases eighteen percent (18%) of the fractional shares 1116 listed by Buyer3.

In a further embodiment, the intellectual property asset fractional payment transactional processing hereunder facilitates a so-called “recoupment” model. As will be appreciated by one skilled in the art, traditionally when a recording label, for example, pays for an artist to record an album, the recording label requires to recoup their initial investment in the artist's recorded album before sharing the profits with the artist generated from the album. Thus, in an embodiment, smart contract 124 may include provisions that trigger such recoupment processing with respect to fractional shares owned. For example, if a fractional owner buys fifty percent (50%) of the ownership for one thousand U.S. dollars ($1,000) and the IP asset that is subject to such fractional share ownership generates one thousand U.S. dollars ($1,000) in revenue (that, in turn, is subject to fractional share ownership revenue distribution as detailed herein above) the IP asset fractional payment system 200, and/or the IP asset fractional payment app 400 managing execution of the smart contract 124 can specify that the fractional owner should first be paid one hundred percent (100%) of the dispersed funds until that fractional owner has fully recouped their initial investment (i.e., the fractional owner is paid one hundred percent (100%) of the first one thousand U.S. dollars ($1,000) then only fifty percent (50%) of each additional payment in accordance with fractional share ownership revenue stream distribution).

The IP asset fractional payment system 200 enables multiple users to know and trust each other in the exchange of fractional ownership. As detailed above, a third party buyer may wish to purchase fractional ownership shares from a specific known third party seller. These parties may remain anonymous as an entity or person, but what is known is the account address of the user. Thus, there is a need to facilitate proof of ownership whereby one user (e.g., the buyer) can validate a specific NFT is present in another user's account (e.g., the seller), representing a fractional ownership. In a further aspect, and as will be detailed further herein below, an intellectual property asset fractional proof of ownership method is provided that facilitates verification of ownership in a trustless system (e.g., the IP asset fractional payment system 200) employing a smart contract on a DLT governing an agreement between an intellectual property creator or owner to show proof of ownership to a plurality of third parties, that facilitates the reporting of a balance of specific NFTs which represent asset ownership. An asset identification code specific to the intellectual property asset is employed as well as an account of individual fractional ownership represented by NFTs. A user device facilitates proof of ownership by a specific known entity in the trustless system and a private key and a public key are employed to prove ownership of an asset in a specific account The IP asset is represented by a digital identifier (e.g., as an NFT), and the account established maintains a balance of the number of specific NFTs held by the creator or owner, including any digital wallets such as MetaMask. In the embodiment, Ethereum may be employed whereby the typical notion of “user” is replaced by that of “accounts” where an account is defined by a set of thirty-two (32) random bytes (i.e., the private key) from which a public key may be derived and an address (which is a hash of the public key). If a piece of data is encrypted using the public key, the data can be decrypted using the private key and vice versa. For example, to make a message only readable by the one designed recipient, it should be encrypted with the recipient's public key. Further, to make a message publicly readable but to prove that the message came from a specific account, the message should be signed with a private key. Using the public key, it is easy to verify that the message came from the specific account by successfully decrypting the message with the public key. As will be appreciated, NFTs are data that resides in a smart contract's storage such that the smart contract serves as a kind of application programming interface (API) that provides standard API interactions such as fetch, insert, modify, and delete. Each of these API interactions may be used to modify data on a blockchain including, but not limited to, Ethereum. Further, NFT smart contracts may be viewed as collections of items where each item has a particular owner such that a token's ID is a parameter that may be used to return the address of the owner and the address may be used as another parameter that returns the number of items owned at that particular address.

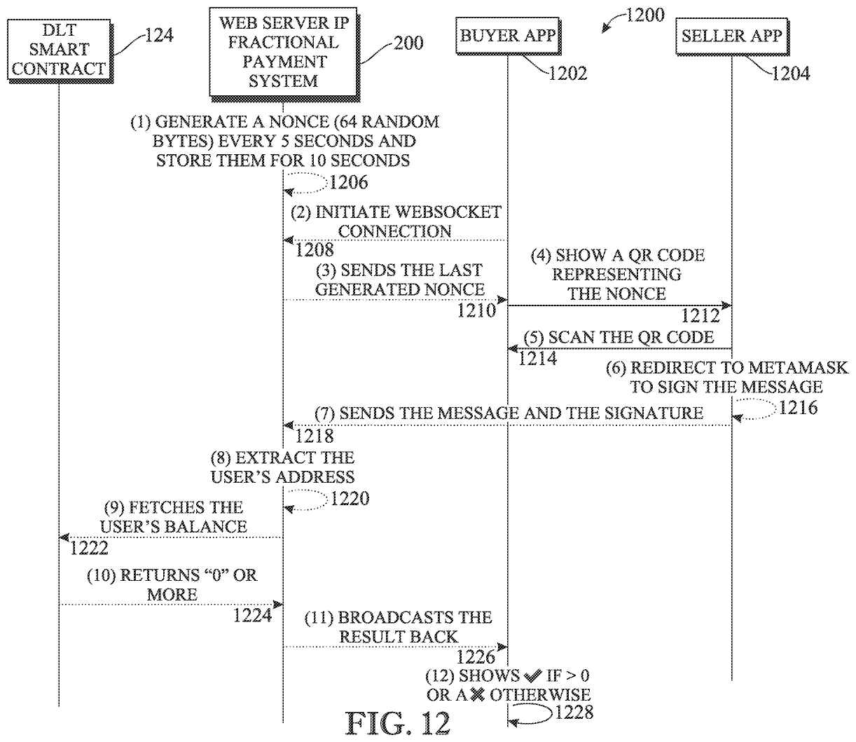

Turning our attention to FIG. 12 to further detail the above proof of ownership aspects of the disclosed embodiments, an exemplary operational and data flow diagram 1200 is shown illustrating proof of ownership of fractional shares in accordance with the embodiment. More particularly, at 1206, the IP asset fractional payment system 200 generates random data (e.g., a nonce) that it holds for a short time and buyer 1202 (e.g., user 2 114) opens the IP asset fractional payment app 400 executing on their user device 300 and initiates a connection to the IP asset fractional payment system 200 in order to subscribe, at 1208, for WebSocket events. At 1210, the IP asset fractional payment system 200 sends the generated nonce to every subscriber as a message and at 1212, the buyer 1202 (through the executing IP asset fractional payment app 400) converts the random data from the IP asset fractional payment system 200 into a QR-code in the app to be presented to seller 1204 (e.g., the creator 1 110-1). At 1214, the seller 1204 scans the QR-code with a mobile device (e.g., their user device 300), which makes a functional request to open the IP asset fractional payment app 400 thereon to sign, at 1216, the message (e.g., using a MetaMask storage app which is a software cryptocurrency wallet used to interact with the Ethereum blockchain). At 1218, the MetaMask opens prompting for the message to be signed, and the message along with the signature are sent to the IP asset fractional payment system 200. At 1220, the IP asset fractional payment system 200 validates the message and if valid extracts the address of the signer from the message and signature. The IP asset fractional payment system 200, at 1222, requests that the smart contract 124 return the balance of the user's NFTs, and the smart contract 124 answers with the balance at 1224 (e.g., will answer zero (0) or more than zero). Then, the IP asset fractional payment system 200, at 1226, broadcasts the balance information back to the executing IP asset fractional payment app 400 on the buyer's 1202 user device 300 that initiated the message. In this way, at 1228, the buyer 1202 will know if the seller's 1204 storage app contains a non-zero balance of the specific NFT this represents and thereby confirms the fractional ownership of the IP asset.

Devices or system modules that are in at least general communication with each other need not be in continuous communication with each other, unless expressly specified otherwise. In addition, devices or system modules that are in at least general communication with each other may com-municate directly or indirectly through one or more intermediaries. Moreover, it is understood that any system components described or named in any embodiment or claimed herein may be grouped or sub-grouped (and accordingly implicitly renamed) in any combination or sub-combination as those skilled in the art can imagine as suitable for the particular application, and still be within the scope and spirit of the claimed embodiments of the present invention. For an example of what this means, if the invention was a controller of a motor and a valve and the embodiments and claims articulated those components as being separately grouped and connected, applying the foregoing would mean that such an invention and claims would also implicitly cover the valve being grouped inside the motor and the controller being a remote controller with no direct physical connection to the motor or internalized valve, as such the claimed invention is contemplated to cover all ways of grouping and/or adding of intermediate components or systems that still substantially achieve the intended result of the invention. A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices. “Software” may refer to prescribed rules to operate a computer. Examples of software may include code segments in one or more computer-readable languages; graphical and or/textual instructions, applets; pre-compiled code; interpreted code; compiled code; and computer programs. A network is a collection of links and nodes (e.g., multiple computers and/or other devices connected together) arranged so that information may be passed from one part of the network to another over multiple links and through various nodes. Examples of networks include the Internet, the public switched telephone network, wireless communications networks, computer networks (e.g., an intranet, an extranet, a local-area network, or a wide-area network), wired networks, and wireless networks.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the func-tions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. Further, although process steps, method steps, algorithms or the like may be described in a sequential order, such processes, methods and algorithms may be configured to work in alternate orders In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically, a processor (e.g., a microprocessor) will receive instructions from a memory or like device, and execute those instructions, thereby performing a process defined by those instructions. Further, programs that implement such methods and algorithms may be stored and transmitted using a variety of known media. When a single device or article is described herein, it will be readily apparent that more than one device/article (whether or not they cooperate) may be used in place of single device/article. Similarly, where more than one device or article is described herein (whether or not they cooperate), it will be readily apparent that a single device/article may be used in place of the more than one device or article. The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-transitory, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that com-prise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, a RAM, a PROM, an EPROM, a FLASH-EEPROM, removable media, flash memory, a “memory stick”, any other memory chip or cartridge, a carrier wave as described hereinafter, or any other medium from which a computer can read. Various forms of computer readable media may be involved in carrying sequences of instructions to a processor. For example, sequences of instruction may be delivered from RAM to a processor, may be carried over a wireless transmission medium, and/or may be formatted according to numerous formats, standards or protocols, such as Bluetooth, 4G, 5G, etc.

Where databases are described, it will be understood by one of ordinary skill in the art that alternative database structures to those described may be readily employed, and other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units. A “network” may refer to a number of computers and associated devices that may be connected by communication facilities. A network may involve permanent connections such as cables or temporary connections such as those made through the telephone or other communication links. A network may further include hard-wired connections (e.g., coaxial cable, twisted pair, optical fiber, waveguides, etc.) and/or wireless connections (e.g., radio frequency waveforms, free space optical waveforms, acoustic waveforms, etc.). Examples of a network may include: an internet, such as the Internet; an intranet; a LAN; a wide area network (WAN); and a combination of networks, such as an internet and an intranet.

As noted above, in some embodiments the method or methods described above may be executed or carried out by a computing system including a tangible computer-readable storage medium, also described herein as a storage machine, that holds machine-readable instructions executable by a logic machine (i.e., a processor or programmable control device) to provide, implement, perform, and/or enact the above-described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI), or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard, or gaming controller. For example, a user input may indicate a request that certain task is to be executed by the computing system, such as requesting the computing system to display any of the above-described information or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Thus, the steps of the disclosed method(s) and the associated discussion herein above can be defined by the computer program instructions stored in a memory and/or data storage device and controlled by a processor executing the computer program instructions. Accordingly, by executing the computer program instructions, the processor executes an algorithm defined by the disclosed method. For example, the computer program instructions can be implemented as computer executable code programmed by one skilled in the art to perform the illustrative operations defined by the disclosed methods. Further, it will be appreciated that any flowcharts, flow diagrams, state transition diagrams, pseudo code, program code and the like represent various processes which may be substantially represented in computer readable medium and so executed by a computer, machine, or processor, whether or not such computer, machine or processor is explicitly shown. One skilled in the art will recognize that an implementation of an actual computer or computer system may have other structures and may contain other components as well, and that a high-level representation of some of the components of such a computer is for illustrative purposes.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. An intellectual property asset fractional payment system comprising:
a processor;
a memory storing instructions that when executed cause the processor to perform operations comprising:
establishing a smart contract on a distributed ledger technology (DLT) governing an agreement by an intellectual property asset owner to offer fractional ownership shares to a plurality of third parties in a revenue stream generated from an intellectual property asset created by an intellectual property asset creator, wherein each fractional ownership share offered entitles any one of third parties to receive a portion of the revenue stream generated from the intellectual property asset commensurate with a number of fractional ownership shares owned by the third party;
assigning, using the smart contract, an asset identification code specific to the intellectual property asset;
receiving from the intellectual property asset owner an identification of an initial number of fractional ownership shares offered for sale to a plurality of third parties;
assigning a first fractional ownership percentage in accordance with the initial number of fractional ownership shares offered for sale;
issuing to the intellectual property asset owner a first digital key comprising the first fractional ownership percentage assigned; and
minting a non-fungible token (NFT) for tokenizing each individual fractional ownership share of the initial number of fractional ownership shares offered for sale.

2. The intellectual property asset fractional payment system of claim 1, wherein the operations performed by the processor further comprise:
publishing the intellectual property asset created by the intellectual property asset creator on a marketplace platform together with the initial number of fractional ownership shares offered for sale.

3. The intellectual property asset fractional payment system of claim 2, wherein the operations performed by the processor further comprise:
receiving a purchasing request from a first one of the plurality of third parties for purchasing a specific number of fractional ownership shares of the initial number of fractional ownership shares offered for sale associated with the intellectual property asset published.

4. The intellectual property asset fractional payment system of claim 3, wherein the operations performed by the processor further comprise:
responsive to the purchasing request received from the first third party, assigning a second fractional ownership percentage in accordance with specific number of fractional ownership shares specified in the purchasing request received;
issuing a second digital key to the first thirst party comprising the second fractional ownership percentage assigned;
adjusting the first fractional ownership percentage assigned by decreasing the first fractional ownership percentage by the second fractional ownership percentage assigned; and
updating the first digital key issued with the first fractional ownership percentage adjusted.

5. The intellectual property asset fractional payment system of claim 4, wherein the operations performed by the processor further comprise:
issuing a first monetary payment to the intellectual property asset owner, the first monetary payment determined as a function of the second fractional ownership percentage assigned and the revenue stream generated from the intellectual property asset.

6. The intellectual property asset fractional payment system of claim 5, wherein the operations performed by the processor further comprise:
receiving a resale request from the first third party to offer for resale a specific number of fractional ownership shares of the second fractional ownership percentage assigned.

7. The intellectual property asset fractional payment system of claim 6, wherein the operations performed by the processor further comprise:
publishing, on the marketplace platform, the specific number of fractional ownership shares of the second fractional ownership percentage assigned offered for resale by the first third party.

8. The intellectual property asset fractional payment system of claim 7, wherein the operations performed by the processor further comprise:
receiving a purchasing request from a second one of the plurality of third parties for a specific number of fractional ownership shares of the specific number of fractional ownership shares of the second fractional ownership percentage assigned offered for resale by the first third party published.

9. The intellectual property asset fractional payment system of claim 8, wherein the operations performed by the processor further comprise:
responsive to the purchasing request received from the second third party, assigning a third fractional ownership percentage in accordance with the specific number of fractional ownership shares of the specific number of fractional ownership shares of the second fractional ownership percentage assigned offered for resale by the first third party;
issuing a third digital key to the second third party comprising the third fractional ownership percentage assigned;
adjusting the first fractional ownership percentage assigned by decreasing the first fractional ownership percentage by the third fractional ownership percentage assigned;
adjusting the second fractional ownership percentage assigned by decreasing the second fractional ownership percentage by the third fractional ownership percentage assigned;
updating the first digital key issued with the first fractional ownership percentage adjusted; and
updating the second digital key issue with the second fractional ownership percentage adjusted.

10. The intellectual property asset fractional payment system of claim 9, wherein the operations performed by the processor further comprise:
issuing a second monetary payment to the intellectual property asset owner, the second monetary payment determined as a function of the third fractional ownership percentage assigned and the revenue stream generated from the intellectual property asset.

11. The intellectual property asset fractional payment system of claim 1, wherein the intellectual property asset is an original work of authorship, a patent, or a trademark.

12. The intellectual property asset fractional payment system of claim 9, wherein the smart contract specifies a date upon which ownership of all fractional ownership shares revert back to the intellectual property owner or the intellectual property creator.

13. The intellectual property asset fractional payment system of claim 2, wherein the publishing of the intellectual property asset on the marketplace platform is administered by and on the DLT.

14. The intellectual property asset fractional payment system of claim 1, wherein the intellectual property asset is represented using an NFT.

15. The intellectual property asset fractional payment system of claim 1, wherein the asset identification code assigned is defined by the intellectual property creator.

16. An intellectual property asset fractional payment system comprising:
a processor;
a memory storing instructions that when executed cause the processor to perform operations comprising:
establishing a smart contract on a distributed ledger technology (DLT) governing an agreement by an intellectual property asset owner to offer fractional ownership shares to a plurality of third parties in a revenue stream generated from an intellectual property asset created by an intellectual property asset creator, wherein each fractional ownership share offered entitles any one of third parties to receive a portion of the revenue stream generated from the intellectual property asset commensurate with a number of fractional ownership shares owned by the third party, wherein the intellectual property asset is an original work of authorship;
assigning, using the smart contract, an asset identification code specific to the intellectual property asset;
receiving from the intellectual property asset owner an identification of an initial number of fractional ownership shares offered for sale to a plurality of third parties;
assigning a first fractional ownership percentage in accordance with the initial number of fractional ownership shares offered for sale;
issuing to the intellectual property asset owner a first digital key comprising the first fractional ownership percentage assigned;
minting a non-fungible token (NFT) for tokenizing each individual fractional ownership share of the initial number of fractional ownership shares offered for sale;
publishing the intellectual property asset created by the intellectual property asset owner on a marketplace platform together with the initial number of fractional ownership shares offered for sale;
receiving a purchasing request from a first one of the plurality of third parties for purchasing a specific number of fractional ownership shares of the initial number of fractional ownership shares offered for sale associated with the intellectual property asset published;
responsive to the purchasing request received from the second third party, assigning a third fractional ownership percentage in accordance with the specific number of fractional ownership shares of the specific number of fractional ownership shares of the second fractional ownership percentage assigned offered for resale by the first third party;
issuing a third digital key to the second third party comprising the third fractional ownership percentage assigned;
adjusting the first fractional ownership percentage assigned by decreasing the first fractional ownership percentage by the third fractional ownership percentage assigned;
adjusting the second fractional ownership percentage assigned by decreasing the second fractional ownership percentage by the third fractional ownership percentage assigned;
updating the first digital key issued with the first fractional ownership percentage adjusted;
updating the second digital key issue with the second fractional ownership percentage adjusted; and
issuing a first monetary payment to the intellectual property asset owner, the first monetary payment determined as a function of the second fractional ownership percentage assigned and the revenue stream generated from the intellectual property asset.

17. The intellectual property asset fractional payment system of claim 16, wherein the operations performed by the processor further comprise:
receiving a resale request from the first third party to offer for resale a specific number of fractional ownership shares of the second fractional ownership percentage assigned.

18. The intellectual property asset fractional payment system of claim 17, wherein the operations performed by the processor further comprise:
publishing, on the marketplace, the specific number of fractional ownership shares of the second fractional ownership percentage assigned offered for resale by the first third party;
receiving a purchasing request from a second one of the plurality of third parties for a specific number of fractional ownership shares of the specific number of fractional ownership shares of the second fractional ownership percentage assigned offered for resale by the first third party published;
responsive to the purchasing request received from the second third party, assigning a third fractional ownership percentage in accordance with the specific number of fractional ownership shares of the specific number of fractional ownership shares of the second fractional ownership percentage assigned offered for resale by the first third party;
issuing a third digital key to the second third party comprising the third fractional ownership percentage assigned;
adjusting the first fractional ownership percentage assigned by decreasing the first fractional ownership percentage by the third fractional ownership percentage assigned;
adjusting the second fractional ownership percentage assigned by decreasing the second fractional ownership percentage by the third fractional ownership percentage assigned;
updating the first digital key issued with the first fractional ownership percentage adjusted;
updating the second digital key issue with the second fractional ownership percentage adjusted; and
issuing a second monetary payment to the intellectual property asset owner, the second monetary payment determined as a function of the third fractional ownership percentage assigned and the revenue stream generated from the intellectual property asset.

19. A non-transitory computer-readable medium having executable code stored thereon, that when executed, cause a computing device to perform operations comprising:
establishing a smart contract on a distributed ledger technology (DLT) governing an agreement by an intellectual property asset owner to offer fractional ownership shares to a plurality of third parties in a revenue stream generated from an intellectual property asset created by an intellectual property asset creator, wherein each fractional ownership share offered entitles any one of third parties to receive a portion of the revenue stream generated from the intellectual property asset commensurate with a number of fractional ownership shares owned by the third party;
assigning, using the smart contract, an asset identification code specific to the intellectual property asset;
receiving from the intellectual property asset owner an identification of an initial number of fractional ownership shares offered for sale to a plurality of third parties,
assigning a first fractional ownership percentage in accordance with the initial number of fractional ownership shares offered for sale;
issuing to the intellectual property asset owner a first digital key comprising the first fractional ownership percentage assigned; and
minting a non-fungible token (NFT) for tokenizing each individual fractional ownership share of the initial number of fractional ownership shares offered for sale.

20. The non-transitory computer-readable medium of claim 19 wherein the operations performed by the computer device further comprise:
publishing the intellectual property asset created by the intellectual property asset creator on a marketplace platform together with the initial number of fractional ownership shares offered for sale;
receiving a purchasing request from a first one of the plurality of third parties for purchasing a specific number of fractional ownership shares of the initial number of fractional ownership shares offered for sale associated with the intellectual property asset published;
responsive to the purchasing request received from the second third party, assigning a third fractional ownership percentage in accordance with the specific number of fractional ownership shares of the specific number of fractional ownership shares of the second fractional ownership percentage assigned offered for resale by the first third party;
issuing a third digital key to the second third party comprising the third fractional ownership percentage assigned;
adjusting the first fractional ownership percentage assigned by decreasing the first fractional ownership percentage by the third fractional ownership percentage assigned;
adjusting the second fractional ownership percentage assigned by decreasing the second fractional ownership percentage by the third fractional ownership percentage assigned;
updating the first digital key issued with the first fractional ownership percentage adjusted;
updating the second digital key issue with the second fractional ownership percentage adjusted;
issuing a first monetary payment to the intellectual property asset owner, the first monetary payment determined as a function of the second fractional ownership percentage assigned and the revenue stream generated from the intellectual property asset;
receiving a resale request from the first third party to offer for resale a specific number of fractional ownership shares of the second fractional ownership percentage assigned;
publishing, on the marketplace, the specific number of fractional ownership shares of the second fractional ownership percentage assigned offered for resale by the first third party;
receiving a purchasing request from a second one of the plurality of third parties for a specific number of fractional ownership shares of the specific number of fractional ownership shares of the second fractional ownership percentage assigned offered for resale by the first third party published;
responsive to the purchasing request received from the second third party, assigning a third fractional ownership percentage in accordance with the specific number of fractional ownership shares of the specific number of fractional ownership shares of the second fractional ownership percentage assigned offered for resale by the first third party;
issuing a third digital key to the second third party comprising the third fractional ownership percentage assigned;
adjusting the first fractional ownership percentage assigned by decreasing the first fractional ownership percentage by the third fractional ownership percentage assigned;
adjusting the second fractional ownership percentage assigned by decreasing the second fractional ownership percentage by the third fractional ownership percentage assigned;
updating the first digital key issued with the first fractional ownership percentage adjusted;
updating the second digital key issue with the second fractional ownership percentage adjusted; and
issuing a second monetary payment to the intellectual property asset owner, the second monetary payment determined as a function of the third fractional ownership percentage assigned and the revenue stream generated from the intellectual property asset.
